(19) United States
(12) Patent Application Publication
(10) Pub. No.: US 2026/0217187 A1
(43) Pub. Date: Jul. 30, 2026

(54) COMPONENT FOR VEHICLE INTERIOR

(71) Applicant: Yanfeng International Automotive Technology Co. Ltd., Novi, MI (US)

(72) Inventors: Diyu CHEN, Shanghai (CN); Jing GU, Shanghai (CN); He YANG, Shanghai (CN); Han QIU, Shanghai (CN)

(21) Appl. No.: 19/629,771

(22) Filed: Mar. 26, 2026

Related U.S. Application Data
(63) Continuation-in-part of application No. PCT/CN2024/120656, filed on Sep. 24, 2024.

(30) Foreign Application Priority Data
Sep. 27, 2023 (CN) 202311257749.X

(51) Int. Cl. B60Q 3/14; B60Q 3/66; F21K 9/68; F21V 7/00; F21V 7/04; F21W 106/00; F21Y 103/10; F21Y 115/10

(52) U.S. Cl. CPC B60Q 3/14; B60Q 3/66; F21K 9/68; F21V 7/0083; F21V 7/045; F21W 2106/00; F21Y 2103/10; F21Y 2115/10

(57) ABSTRACT

A component for a vehicle interior configured to transmit light from a light source is disclosed. The component may comprise a composite structure comprising a substrate and cover and set of features (e.g. projections); the cover may comprise a light-transmissive layer; the set of features is configured to direct/reflect light from light source within cover toward the exterior surface of the cover; a visual effect is presented at the cover; the visual effect may comprise light effect (e.g. illumination, etc.) and decorative effect (e.g. texture, color, surface effect, etc.). The set of features is configured to present the light effect at the exterior surface of cover; light effect may comprise an image/pattern of features in an arrangement to present the image; light effect may comprise illumination, color effect, dynamic effect, depth effect, luminescence, directed light, reflected light, scattered/refracted light. The component may comprise a console, a panel, trim component, etc.

### CROSS-REFERENCE TO RELATED APPLICATIONS

The present application is a continuation-in-part of PCT/International Patent Application No. PCT/CN2024/120656 titled “LIGHT-EMITTING ORNAMENT FOR VEHICLE, AND INTERIOR ORNAMENT FOR VEHICLE” filed Sep. 24, 2024, that claims the benefit of Chinese Patent Application No. 202311257749.X titled “ILLUMINATED TRIM FOR VEHICLE AND VEHICLE” filed Sep. 27, 2023.

The present application claims priority to and incorporates by reference in full: (1) PCT/International Patent Application No. PCT/CN2024/120656 titled “LIGHT-EMITTING ORNAMENT FOR VEHICLE, AND INTERIOR ORNAMENT FOR VEHICLE” filed Sep. 24, 2024; and (2) Chinese Patent Application No. 202311257749.X titled “ILLUMINATED TRIM FOR VEHICLE AND VEHICLE” filed Sep. 27, 2023.

### FIELD

The present invention relates to a component for a vehicle interior.

The present invention relates to a component for a vehicle interior comprising a luminous trim component.

### BACKGROUND

It is known to provide illuminated trim components for a vehicle interior (e.g., door panels, dashboards, roofs, etc.).

It would be advantageous to provide an improved vehicle interior component comprising a composite structure configured to provide a visual effect comprising a light effect and a decorative effect.

It would be advantageous to provide an improved vehicle interior component comprising a composite structure comprising a cover and a substrate configured to provide a visual effect comprising a light effect and a decorative effect.

It would be advantageous to provide an improved vehicle interior component comprising a composite structure comprising a cover and a substrate and a set of features configured to provide a visual effect comprising a light effect and a decorative effect.

It would be advantageous to provide an improved vehicle interior component comprising a composite structure comprising a cover and a substrate and a set of features configured to provide the light effect of the visual effect.

It would be advantageous to provide an improved vehicle interior component comprising a composite structure comprising a cover and a substrate and a set of features configured to provide the light effect by reflection/refraction/scattering of light from a light source toward the exterior surface of the cover.

It would be advantageous to provide an improved vehicle interior component comprising a composite structure comprising a cover comprising a light-transmissive material and a substrate and a set of features configured to provide the light effect by reflection/refraction/scattering of light from a light source through the light-transmissive material toward the exterior surface of the cover.

It would be advantageous to provide an improved vehicle interior component comprising a composite structure comprising a cover comprising a light-transmissive material such as a light guide and a substrate and a set of features configured to provide the light effect by reflection/refraction/scattering of light from a light source through the light guide toward the exterior surface of the cover.

It would be advantageous to provide an improved vehicle interior component comprising a composite structure comprising a cover comprising a light-transmissive material such as a light guide and a substrate and a set of features configured to provide the light effect by reflection/refraction/scattering of light from a light source within and through the light guide toward the exterior surface of the cover.

It would be advantageous to provide an improved vehicle interior component comprising a composite structure comprising a cover and a substrate and a set of features configured to provide the light effect by reflection/refraction/scattering of light from a light source toward the exterior surface of the cover and a decorative effect from a decorative/intermediate layer of the composite structure to provide the visual effect of light effect and decorative effect.

### SUMMARY

The present invention relates to a component for a vehicle interior configured to transmit light from a light source into the vehicle interior comprising a composite structure comprising a substrate and a cover and a set of features; the cover may comprise a light-transmissive layer and an exterior surface; the set of features may be configured to direct light from the light source within the light-transmissive layer of the cover toward the exterior surface of the cover; the composite structure may be configured to present a visual effect at the cover; the visual effect may comprise a light effect by light from the light source. The visual effect may comprise a decorative effect from the composite structure; the visual effect may comprise the light effect and/or the decorative effect; the composite structure may be configured to present the visual effect on and/or in the cover; the composite structure may be configured to present the light effect on and/or within the cover; the set of features of the composite structure may be configured to present the light effect at the exterior surface of the cover; the light effect may comprise an image; the image may comprise a pattern; the pattern may comprise the set of features; the set of features may be configured to direct and/or scatter light from the light source within the light-transmissive layer of the cover and to direct and/or scatter light toward the exterior surface of the cover; the light effect may comprise a color effect; the light effect may comprise a three-dimensional effect; the decorative effect may comprise a surface effect at the exterior surface of the cover; the light source may comprise an LED arrangement; an interface may be provided between the light source and the composite structure; the interface may comprise a surface on an edge of the cover of the composite structure; the composite structure may comprise a matrix comprising the set of features; the set of features may comprise a pattern of projections configures to present the image; the set of features may comprise a set of formed features; the set of features may comprise a set of optically-reflecting features in a pattern; the set of features may be formed at the cover; the set of features may comprise formed by embossing and/or micro-nano embossing and/or printing and/or screen printing and/or imprinting and/or ultraviolet imprinting and/or etching and/or engraving; the cover may comprise a multi-layer assembly; the cover may comprise at least one film layer; the cover may comprise a molded layer; the cover may comprise a coating; the cover may be formed on the substrate; the composite structure may comprise an interface between the light source and the cover; the component may comprise a console and/or a panel and/or a trim component and/or an instrument panel and/or a door panel and/or a floor console and/or an overhead console.

The present invention relates to a component for a vehicle interior configured to transmit light from a light source into the vehicle interior; the component may comprise a composite structure comprising a substrate and a cover and a set of features; the cover may comprise a light-transmissive layer and an exterior surface; the set of features may be configured to direct light from the light source within the light-transmissive layer of the cover toward the exterior surface of the cover; the composite structure may be configured to present a visual effect at the cover; the visual effect may comprise a light effect by light from the light source. The visual effect may comprise a decorative effect from the composite structure; the decorative effect may be provided by a decorative material of the composite structure; the decorative effect may be provided by a decorative layer of the composite structure; the decorative effect may be provided by a decorative material at the cover of the composite structure; the decorative effect may be provided by a decorative layer at the cover of the composite structure; the visual effect may comprise the light effect and/or the decorative effect; the visual effect may comprise the light effect and the decorative effect; the visual effect may comprise the decorative effect when no light may be provided; the visual effect may comprise the decorative effect when no light may be provided there may be no light effect.

The present invention relates to a component for a vehicle interior configured to transmit light from a light source into the vehicle interior; the component may comprise a composite structure comprising a substrate and a cover and a set of features; the cover may comprise a light-transmissive layer and an exterior surface; the set of features may be configured to direct light from the light source within the light-transmissive layer of the cover toward the exterior surface of the cover; the composite structure may be configured to present a visual effect at the cover; the visual effect may comprise a light effect by light from the light source. The composite structure may be configured to present the visual effect at the cover; the composite structure may be configured to present the visual effect on the cover; the composite structure may be configured to present the visual effect on and/or in the cover; the composite structure may be configured to present the visual effect on and/or within the cover; the composite structure may be configured to present the visual effect at the exterior surface of the cover; the composite structure may be configured to present the light effect on the cover; the composite structure may be configured to present the light effect on and/or in the cover; the composite structure may be configured to present the light effect on and/or within the cover; the composite structure may be configured to present the light effect at the exterior surface of the cover.

The present invention relates to a component for a vehicle interior configured to transmit light from a light source into the vehicle interior; the component may comprise a composite structure comprising a substrate and a cover and a set of features; the cover may comprise a light-transmissive layer and an exterior surface; the set of features may be configured to direct light from the light source within the light-transmissive layer of the cover toward the exterior surface of the cover; the composite structure may be configured to present a visual effect at the cover; the visual effect may comprise a light effect by light from the light source. The set of features of the composite structure may be configured to present the light effect on the cover; the set of features of the composite structure may be configured to present the light effect on and/or in the cover; the set of features of the composite structure may be configured to present the light effect on and/or within the cover; the set of features of the composite structure may be configured to present the light effect at the exterior surface of the cover; the visual effect may comprise an image; the light effect may comprise an image; the image may comprise an icon; the image may comprise a pattern; the image may comprise information; the image may comprise a pattern; the pattern may comprise the set of features; the pattern may comprise the image.

The present invention relates to a component for a vehicle interior configured to transmit light from a light source into the vehicle interior; the component may comprise a composite structure comprising a substrate and a cover and a set of features; the cover may comprise a light-transmissive layer and an exterior surface; the set of features may be configured to direct light from the light source within the light-transmissive layer of the cover toward the exterior surface of the cover; the composite structure may be configured to present a visual effect at the cover; the visual effect may comprise a light effect by light from the light source. Light from the light source may be configured to present the light effect at the exterior surface of the cover; the set of features may be configured to present the image at the exterior surface of the cover; the set of features may comprise a pattern configured to present the image at the exterior surface of the cover; the set of features may comprise an arrangement configured to present the image at the exterior surface of the cover; the set of features may be configured to direct light from the light source within the light-transmissive layer of the cover and to reflect light toward the exterior surface of the cover; the set of features may be configured to direct light from the light source within the light-transmissive layer of the cover and to reflect and/or refract light toward the exterior surface of the cover; the set of features may be configured to reflect and/or refract light from the light source within the light-transmissive layer of the cover and to reflect and/or refract light toward the exterior surface of the cover; the set of features may be configured to reflect and/or scatter light from the light source within the light-transmissive layer of the cover and to reflect and/or scatter light toward the exterior surface of the cover; the set of features may be configured to direct and/or scatter light from the light source within the light-transmissive layer of the cover and to direct and/or scatter light toward the exterior surface of the cover; the set of features may be configured to direct light from the light source within the light-transmissive layer of the cover and to direct light toward the exterior surface of the cover to provide the light effect; the set of features may be configured to direct light from the light source within the light-transmissive layer of the cover and to direct light toward the exterior surface of the cover to provide the image;

The present invention relates to a component for a vehicle interior configured to transmit light from a light source into the vehicle interior; the component may comprise a composite structure comprising a substrate and a cover and a set of features; the cover may comprise a light-transmissive layer and an exterior surface; the set of features may be configured to direct light from the light source within the light-transmissive layer of the cover toward the exterior surface of the cover; the composite structure may be configured to present a visual effect at the cover; the visual effect may comprise a light effect by light from the light source. The light effect may comprise a color effect; the light effect may comprise a multi-color effect; the light effect may comprise a dynamic effect; the light effect may comprise a multi-layer effect; the light effect may comprise a three-dimensional effect; the light effect may comprise luminance; the light effect may comprise directed light; the light effect may comprise reflected light; the light effect may comprise scattered light; the light effect may comprise reflected light and/or refracted light; the visual effect may comprise a decorative effect from the composite structure; the decorative effect may be provided by a decorative material of the composite structure; the decorative effect may be provided by a decorative layer of the composite structure; the decorative effect may comprise a texture; the decorative effect may comprise a grain; the decorative effect may comprise a color; the decorative effect may comprise a surface effect; the decorative effect may comprise a surface effect at the exterior surface of the cover; the visual effect may comprise a depth effect; the light source may comprise a lamp; the light source may comprise an LED; the light source may comprise an LED arrangement; the light source may comprise a side light; the light source may comprise a light module; the light module may comprise a light guide; the light module may comprise a color light source; the light module may comprise a multi-color light source; the light module may comprise a multi-layer light source; the light module may comprise a multi-layer light guide; the light module may comprise an outlet for light; the light source may comprise an outlet for light; the outlet for light may comprise an aperture; the outlet for light may comprise a set of apertures; light from the light source may be directed into the composite structure; light from the light source may be directed into the cover of the composite structure; an interface may be provided between the light source and the composite structure; the interface may comprise a surface on the composite structure; the interface may comprise a surface on an edge of the cover of the composite structure; light may be transmitted from the light source through the interface to the composite structure; light may be transmitted from the light source through the interface to the cover of the composite structure.

The present invention relates to a component for a vehicle interior configured to transmit light from a light source into the vehicle interior; the component may comprise a composite structure comprising a substrate and a cover and a set of features; the cover may comprise a light-transmissive layer and an exterior surface; the set of features may be configured to direct light from the light source within the light-transmissive layer of the cover toward the exterior surface of the cover; the composite structure may be configured to present a visual effect at the cover; the visual effect may comprise a light effect by light from the light source. The cover may comprise a light-guide layer; the light-transmissive layer may comprise a light-guide layer; the substrate may comprise the set of features; the cover may comprise the set of features; the set of features may be on the substrate; the set of features may be under the cover; the substrate may comprise a substrate/matrix comprising the set of features; the cover may comprise a substrate/matrix comprising the set of features; the set of features may between the substrate and the cover; the composite structure may comprise a substrate/matrix comprising the set of features; the set of features may be within the matrix; the set of features may comprise at least one feature; the set of features may comprise at least one projection; the set of features may comprise a pattern of features; the set of features may comprise a pattern of features configured to present the image; the set of features may comprise a pattern of projections configures to present the image; the set of features may comprise at least one recess; the set of features may comprise a set of recesses; a feature of the set of features may comprise a projection; a feature of the set of features may comprise a recess; the set of features may comprise a set of projections; the set of projections may comprise a pattern of projections; the set of projections may comprise a row of projections; the set of features may comprise a set of dots; the set of features may comprise a set of dots of deposited material; the set of features may comprise a uniform set of features; the set of features may comprise a set of applied features; the set of features may comprise a set of deposited features; the set of features may comprise a set of printed features; the set of features may comprise a set of formed features; the set of features may comprise a set of molded features; the set of features may comprise a set of rounded features; the set of features may comprise a set of curved features; the set of features may comprise a set of curved-shaped features; the set of features may comprise a set of block-shaped features; the set of features may comprise a set of flat-sided features; the set of features may comprise a set of bumps; the set of features may comprise a set of blocks; the set of features may comprise a set of optically-reflecting features; the set of features may comprise a set of structures; the set of features may comprise a set of optically-reflecting structures; the set of features may comprise a set of optical features; the set of features may comprise a set of optically-reflecting features in a pattern; the set of features may comprise a set of optical structures in a pattern; the set of features may comprise a pattern of features; the set of features may be configured to reflect light from within the light-transmissive layer of the cover through the exterior surface of the cover; the set of features may be formed at the cover; the set of features may be formed in the cover; the set of features may be formed into the cover; the set of features may comprise a set of optical microstructures in a pattern formed at the cover; the set of features may comprise formed by embossing and/or micro-nano embossing and/or printing and/or screen printing and/or imprinting and/or ultraviolet imprinting and/or etching and/or engraving.

The present invention relates to a component for a vehicle interior configured to transmit light from a light source into the vehicle interior; the component may comprise a composite structure comprising a substrate and a cover and a set of features; the cover may comprise a light-transmissive layer and an exterior surface; the set of features may be configured to direct light from the light source within the light-transmissive layer of the cover toward the exterior surface of the cover; the composite structure may be configured to present a visual effect at the cover; the visual effect may comprise a light effect by light from the light source. The cover may comprise a membrane layer; the light-transmissive layer of the cover may comprise a light-guide layer; the cover may comprise a photo guide; the cover may comprise a cover assembly; the cover may comprise a multi-layer assembly; the cover may comprise a film; the cover may comprise a film material; the cover may comprise a film layer; the cover may comprise at least one film layer; the cover may comprise multi-film layer; the cover may comprise a cover layer; the cover may comprise a single layer; the cover may comprise a multi-layer cover; the cover may comprise a molded layer; the cover may comprise a multi-layer molded cover; the cover may comprise a backing layer; the cover may comprise a backing; the cover may comprise a reflective backing; the cover may comprise a coating; the cover may comprise a PVD coating; the cover may comprise a light-transmissive coating; the cover may comprise a coating at the exterior surface; the cover may comprise a protective layer; the cover may comprise a transparent protective layer; the cover may comprise a decorative layer; the cover may comprise a decorative layer configured to provide the decorative effect; the cover may comprise a luminescent cover; the cover may comprise a luminescent cover configured to provide the light effect; the cover may be formed on the substrate; the cover may be molded on the substrate; the cover may be injection-molded on the substrate; the cover may be bonded on the substrate; the composite structure may comprise an adhesive layer between the cover and the substrate;

The present invention relates to a component for a vehicle interior configured to transmit light from a light source into the vehicle interior; the component may comprise a composite structure comprising a substrate and a cover and a set of features; the cover may comprise a light-transmissive layer and an exterior surface; the set of features may be configured to direct light from the light source within the light-transmissive layer of the cover toward the exterior surface of the cover; the composite structure may be configured to present a visual effect at the cover; the visual effect may comprise a light effect by light from the light source. The set of features may be formed onto the substrate; the set of features may be formed on the substrate; the substrate may comprise a base layer; the substrate may comprise a panel; the substrate may comprise a carrier; the substrate may comprise a plate; the substrate may comprise a base; a feature of the set of features may comprise at least one of a structure and/or a micro-structure and/or an optical micro-structure and/or a deposited material and/or a dot and/or a projection and/or a formed projections and/or a recess; the set of features may comprise a layer and/or a pattern and/or a preset pattern and/or a matrix; the light-transmissive layer may comprise a light transmissive material and/or a light-guide layer and/or a light guiding film and/or a light guide film; the cover may comprise a backing layer and/or a light-reflective layer and/or a light-reflective material and/or a light reflective surface and/or a light-emitting surface and/or a cover surface and/or a translucent surface decorative layer and/or a luminous surface and/or a surface decorative layer and/or light-transmissive area and/or a light-transmissive area and/or a generally opaque area and/or a non-light transmitting area and/or a light-transmissive protective layer and/or a generally transparent protective layer and/or a protective layer and/or a light output surface; the composite structure may comprise the light source; the composite structure may comprise an interface between the light source and the cover; the composite structure may comprise an optical coupling between the light source and the cover; the component may comprise a luminous component; the component may comprise a light-emitting component; the component may comprise a console and/or a panel and/or a trim component and/or an instrument panel and/or a door panel and/or a floor console and/or an overhead console.

### FIGURES

FIG. 1 is a schematic perspective view of a vehicle according to an exemplary embodiment.

FIG. 2 is a schematic perspective cut-away view of a vehicle showing a vehicle interior according to an exemplary embodiment.

FIGS. 2A and 2B are schematic perspective views of a component for a vehicle interior according to an exemplary embodiment.

FIG. 2C is a schematic detail top plan view of a component for a vehicle interior according to an exemplary embodiment.

FIG. 2D is a schematic detail side elevation view of a component for a vehicle interior according to an exemplary embodiment.

FIG. 3 is a schematic side elevation view of a component for a vehicle interior according to an exemplary embodiment.

FIG. 3A is a schematic perspective view of a component for a vehicle interior according to an exemplary embodiment.

FIG. 4 is a schematic side elevation view of a component for a vehicle interior according to an exemplary embodiment.

FIG. 4A is a schematic perspective view of a component for a vehicle interior according to an exemplary embodiment.

FIG. 5 is a schematic detail view of a component for a vehicle interior according to an exemplary embodiment.

FIG. 5A is a schematic perspective view of a component for a vehicle interior according to an exemplary embodiment.

FIG. 5B is a schematic perspective section view of a component for a vehicle interior according to an exemplary embodiment.

FIG. 5C is a schematic side elevation section view of a component for a vehicle interior according to an exemplary embodiment.

FIG. 6 is a schematic detail view of a component for a vehicle interior according to an exemplary embodiment.

FIG. 7 is a schematic side elevation view of a component for a vehicle interior according to an exemplary embodiment.

FIG. 7A is a schematic perspective view of a component for a vehicle interior according to an exemplary embodiment.

FIG. 8 is a schematic side elevation view of a component for a vehicle interior according to an exemplary embodiment.

FIG. 8A is a schematic perspective view of a component for a vehicle interior according to an exemplary embodiment.

FIG. 9 is a schematic side elevation view of a component for a vehicle interior according to an exemplary embodiment.

FIG. 9A is a schematic perspective view of a component for a vehicle interior according to an exemplary embodiment.

FIG. 10 is a schematic side elevation view of a component for a vehicle interior according to an exemplary embodiment.

FIG. 10A is a schematic perspective view of a component for a vehicle interior according to an exemplary embodiment.

FIGS. 11A through 11G are schematic view of a pattern formed by a component for a vehicle interior according to an exemplary embodiment.

FIG. 12 is a schematic perspective view of a component for a vehicle interior according to an exemplary embodiment.

FIGS. 12A through 12C are schematic side elevation views of a component for a vehicle interior according to an exemplary embodiment.

FIG. 13 is a schematic top plan view of a component for a vehicle interior according to an exemplary embodiment.

FIG. 14 is a schematic top plan view of a component for a vehicle interior according to an exemplary embodiment.

FIG. 14A is a schematic side elevation section view of a component for a vehicle interior according to an exemplary embodiment.

FIG. 15 is a schematic top plan views of a component for a vehicle interior according to an exemplary embodiment.

FIG. 15A is a schematic perspective view of a component for a vehicle interior according to an exemplary embodiment.

FIG. 15B is a schematic side elevation section view of a component for a vehicle interior according to an exemplary embodiment.

FIG. 16 is a schematic side elevation view of a component for a vehicle interior according to an exemplary embodiment.

FIG. 16A is a schematic perspective view of a component for a vehicle interior according to an exemplary embodiment.

FIG. 16B is a schematic detail view of a component for a vehicle interior according to an exemplary embodiment.

FIG. 16C is a schematic perspective view of a component for a vehicle interior according to an exemplary embodiment.

FIG. 17 is a schematic side elevation view of a component for a vehicle interior according to an exemplary embodiment.

FIG. 17A is a schematic perspective view of a component for a vehicle interior according to an exemplary embodiment.

FIG. 18 is a schematic side elevation view of a component for a vehicle interior according to an exemplary embodiment.

FIG. 18A is a schematic perspective view of a component for a vehicle interior according to an exemplary embodiment.

### DESCRIPTION

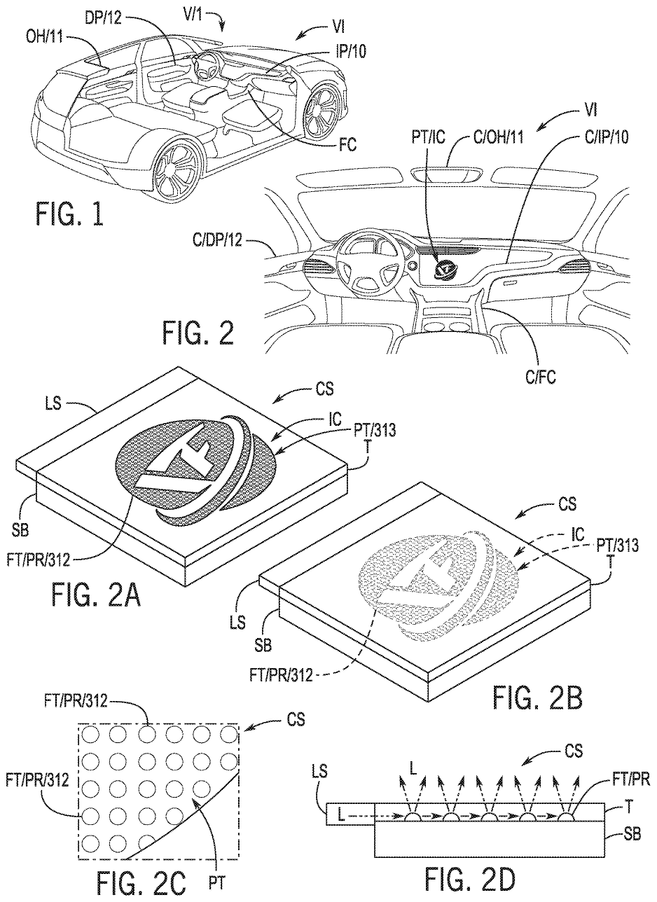

Referring to FIGS. 1 and 2, a vehicle V/1 with an interior VI is shown according to an exemplary embodiment; vehicle interior VI comprises components C such as panels, consoles, trim components, etc. including instrument panel IP/10 and overhead panel/system OH/11 and door panel DP/12 and floor console FC; as indicated schematically in FIGS. 2, 2A-2D, 5, 5A-5C and 6, the component C may comprise a composite structure CS comprising a substrate SB/20 and a cover T comprising a light-transmissive/guide layer 30 coupled to a light source LS; the component C comprising composite structure CS is configured to provide a visual effect comprising a light effect and a decorative effect.

As shown schematically in FIGS. 2, 2A-2C, 3, 3A, 4, 4A, 5, 5A-5C and 6, the vehicle interior component C comprising a composite structure CS may comprise a cover T comprising a light-transmissive material shown as light guide/film 30 and a substrate SB/20 and a set of features FT shown as projections PR/312 arranged in a pattern PT/313 configured to provide the light effect by reflection/refraction/scattering of light L from a light source LS within and through and toward the exterior surface of the cover T to provide an image IC. As shown schematically in FIGS. 2, 2A-2C, 3, 3A, 4, 4A, 5, 5A-5C and 6, the vehicle interior component C comprising a composite structure CS may comprise a cover T comprising a light-transmissive material shown as light guide/film 30 and a substrate SB/20 and a set of features FT/PR configured to provide the light effect by reflection/refraction/scattering of light L from a light source LS within and through and toward the exterior surface of the cover T and a decorative effect from a decorative/intermediate layer DL/NL of the composite structure CS; a composite visual effect of the component C comprises the light effect including image IC and the decorative effect. See also FIGS. 12, 12A-12C, 16, 16A-16C, 17, 17A, 18 and 18A.

### Exemplary Embodiments—A

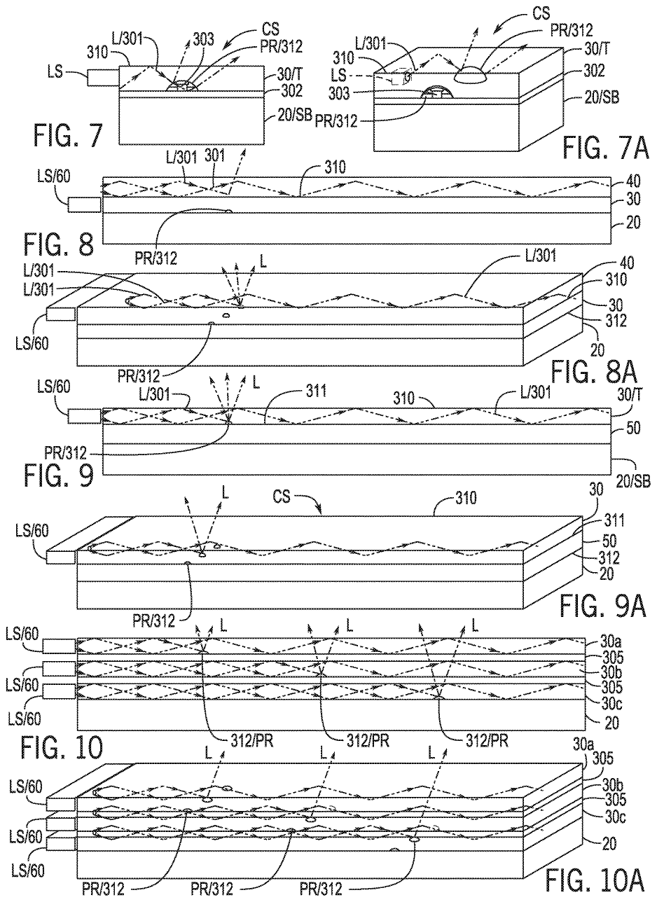

According to an exemplary embodiment as shown schematically in FIGS. 2, 2A-2C, 3, 3A, 4, 4A, 5, 5A-5C and 6, the component C for a vehicle interior configured to transmit light from a light source LS into the vehicle interior VI may comprise a composite structure CS comprising a substrate SB/20 and a cover T/30 and a set of features FT; the cover T/30 may comprise a light-transmissive layer 30 and an exterior surface; the set of features FT is configured to direct light from the light source LS within the light-transmissive layer 30 of the cover T/30 toward the exterior surface of the cover T/30; the composite structure CS is configured to present a visual effect at the cover T/30; the visual effect may comprise a light effect by light from the light source LS; the visual effect may comprise a decorative effect from the composite structure CS; the composite structure CS may comprise a decorative layer DL and/or an intermediate layer NL. See also FIGS. 7, 7A, 8, 8A, 9, 9A, 10, 10A, 12, 12A-12C, 16, 16A-16C, 17, 17A, 18 and 18A.

As shown schematically in FIGS. 2, 2A-2C, 3, 3A, 4, 4A, 5, 5A-5C and 6, the composite structure CS of component C may be configured to present the visual effect on and/or in the cover T/30 and/or within the cover T/30; the visual effect may comprise the light effect and/or the decorative effect. As shown schematically in FIGS. 2, 2A-2C, 3, 3A, 4, 4A, 5, 5A-5C, 6, 7, 7A, 8, 8A, 9, 9A, 10 and 10A, the composite structure CS may comprise an interface between the light source LS and the cover T/30 to provide light L to illuminate the set of features FT/PR of the composite structure CS configured to present the light effect at the exterior surface of the cover T/30; the light effect may comprise an image IC and/or a pattern PT; the pattern PT may comprise the set of features FT; the set of features FT may comprise an arrangement configured to present the image IC at the exterior surface of the cover T/30; the light effect may comprise a color effect and/or a multi-color effect and/or a dynamic effect and/or a multi-layer effect; the light effect may comprise a three-dimensional effect; the light effect may comprise illumination and/or luminesce and/or directed light and/or scattered light and/or reflected light and/or refracted light. See also FIGS. 12, 12A-12C, 16, 16A-16C, 17, 17A, 18 and 18A.

As shown schematically in FIGS. 2, 2A-2C, 3, 3A, 4, 4A, 5, 5A-5C, 6, 7, 7A, 8, 8A, 9, 9A, 10 and 10A, the set of features FT is configured to direct light from the light source LS within the light-transmissive layer 30 of the cover T/30 and to reflect light toward the exterior surface of the cover T/30; the set of features FT of the composite structure CS is configured to present the light effect at the exterior surface of the cover T/30; the light effect may comprise an image IC and/or a pattern PT; the pattern PT may comprise the set of features FT; the set of features FT may comprise an arrangement configured to present the image IC at the exterior surface of the cover T/30; the set of features FT is configured to direct light from the light source LS within the light-transmissive layer 30 of the cover T/30 and to reflect light toward the exterior surface of the cover T/30; the set of features FT is configured to reflect and/or refract light from the light source LS within the light-transmissive layer 30 of the cover T/30 and to reflect and/or refract light toward the exterior surface of the cover T/30; the set of features FT is configured to direct and/or scatter light from the light source LS within the light-transmissive layer 30 of the cover T/30 and to direct and/or scatter light toward the exterior surface of the cover T/30; the set of features FT is configured to direct light from the light source LS within the light-transmissive layer 30 of the cover T/30 and to direct light toward the exterior surface of the cover T/30 to provide the image IC. See also FIGS. 12, 12A-12C, 16, 16A-16C, 17, 17A, 18 and 18A.

As indicated schematically in FIGS. 2, 2A-2C, 3, 3A, 4, 4A, 5, 5A-5C and 6, the light effect may comprise a color effect and/or a multi-color effect and/or a dynamic effect and/or a multi-layer effect; the light effect may comprise a three-dimensional effect; the light effect may comprise illumination and/or luminesce and/or directed light and/or scattered light and/or reflected light and/or refracted light; the decorative effect may comprise a surface effect and/or a texture and/or a grain and/or a color; the decorative effect may comprise a surface effect at the exterior surface of the cover T/30; the visual effect may comprise a depth effect. See also FIGS. 10, 10A, 11A-11G, 12, 12A-12C, 16, 16A-16C, 17, 17A, 18 and 18A.

As indicated schematically in FIGS. 2, 2A-2C, 3, 3A, 4, 4A, 5, 5A-5C and 6, the light source LS may comprise a lamp and/or an LED and/or an LED arrangement to provide light L for illumination of the composite structure CS at the cover T; the light source LS may comprise a side light and/or a light module and/or a light guide and/or a color light source LS and/or a multi-color light source LS and/or a multi-layer light source LS and/or a multi-layer light guide and/or an outlet for light; the light source LS may comprise an outlet for light; the outlet for light may comprise a set of apertures; light from the light source LS is directed into the composite structure CS; light from the light source LS is directed into the cover T/30 of the composite structure CS; an interface may be provided between the light source LS and the composite structure CS; the interface may comprise a surface on the composite structure CS; the interface may comprise a surface on an edge of the cover T/30 of the composite structure CS; light is transmitted from the light source LS through the interface to the composite structure CS; light is transmitted from the light source LS through the interface to the cover T/30 of the composite structure CS. As indicated schematically in FIGS. 2, 2A-2C, 3, 3A, 4, 4A, 5, 5A-5C, 6, 7, 7A, 8, 8A, 9, 9A, 10 and 10A, the composite structure CS may comprise the light source LS; the composite structure CS may comprise an interface between the light source LS and the cover T/30; the composite structure CS may comprise an optical coupling between the light source LS and the cover T/30. See also FIGS. 12, 12A-12C, 16, 16A-16C, 17, 17A, 18 and 18A.

As indicated schematically in FIGS. 2, 2A-2C, 3, 3A, 4, 4A, 5, 5A-5C, 6, 7, 7A, 8, 8A, 9, 9A, 10 and 10A, the cover T/30 may comprise a light-guide layer; the light-transmissive layer 30 may comprise a light-guide layer; the substrate SB/20 may comprise the set of features FT; the cover T/30 may comprise the set of features FT; the set of features FT may be on the substrate SB; the set of features FT may be under the cover T/30; the set of features FT may be between the substrate SB/20 and the cover T/30; the composite structure CS may comprise a matrix comprising the set of features FT; the set of features FT may be within the matrix of the composite structure CS. See also FIGS. 12, 12A-12C, 16, 16A-16C, 17, 17A, 18 and 18A.

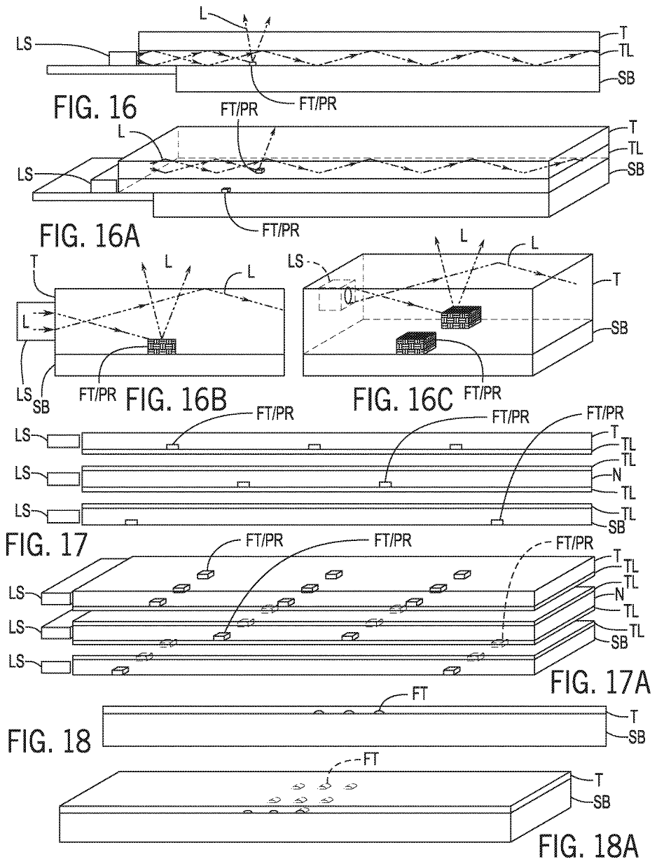

As indicated schematically in FIGS. 2, 2A-2C, 3, 3A, 4, 4A, 5, 5A-5C, 6, 7, 7A, 8, 8A, 9, 9A, 10 and 10A, the set of features FT may comprise a pattern PT of features FT configured to present the image IC; the set of features FT may comprise a pattern PT of projections PR configured to present the image IC; the set of features FT may comprise a set of recesses (see FIGS. 12, 12A-12C, 18 and 18A); a feature of the set of features FT may comprise a projection (see FIG. 2D); a feature of the set of features FT may comprise a recess; the set of features FT may comprise a set of projections PR; the set of projections PR may comprise a row of projections PR; the set of features FT may comprise a set of dots and/or a set of dots of deposited material and/or a uniform set of features FT and/or a set of applied features FT and/or a set of deposited features FT and/or a set of printed features FT (see FIGS. 17, 17A, 18 and 18A); the set of features FT may comprise a set of formed features FT and/or a set of molded features FT and/or a set of rounded features FT and/or a set of curved features FT and/or a set of curved-shaped features FT and/or a set of block-shaped features FT and/or a set of flat-sided features FT and/or a set of bumps and/or a set of blocks (see FIGS. 16 and 16A-16C); the set of features FT may comprise a set of structures and/or a set of optically-reflecting structures and/or a set of optical features FT and/or a set of optically-reflecting features FT and/or a set of optically-reflecting features FT in a pattern PT and/or a set of optical structures in a pattern PT; the set of features FT may comprise a pattern PT of features FT; the set of features FT may be configured to reflect light from within the light-transmissive layer 30 of the cover T/30 through the exterior surface of the cover T/30; the set of features FT may be formed at the cover T/30 and/or in the cover T/30 and/or into the cover T/30; the set of features FT may comprise a set of optical microstructures in a pattern PT formed at the cover T/30; the set of features FT may be formed onto the substrate SB/20 and/or on the substrate SB/20; the substrate SB/20 may comprise a base layer and/or a panel and/or a carrier and/or a plate and/or a base and/or a carrier and/or a flexible support; a feature of the set of features FT may comprise at least one of a structure and/or a micro-structure and/or an optical micro-structure and/or a deposited material and/or a dot and/or a projection and/or a formed projections PR and/or a recess; the set of features FT may comprise a layer and/or a pattern PT and/or a preset pattern PT and/or a matrix. See also FIGS. 12, 12A-12C, 16, 16A-16C, 17, 17A, 18 and 18A.

As indicated schematically, the set of features FT may comprise formed by embossing and/or micro-nano embossing and/or printing and/or screen printing and/or imprinting and/or ultraviolet imprinting and/or etching and/or engraving.

As shown schematically in FIGS. 2, 2A-2C, 3, 3A, 4, 4A, 5, 5A-5C, 6, 7, 7A, 8, 8A, 9, 9A, 10 and 10A, the cover may comprise a cover assembly T and/or a multi-layer assembly and/or a film and/or a film material and/or a film layer and/or at least one film layer and/or a multi-film layer; the cover may comprise a cover assembly T and/or a cover layer and/or a single layer and/or a multi-layer cover; the cover T/30 may comprise a molded layer and/or a multi-layer molded cover; the cover T/30 may comprise a backing layer and/or a backing and/or a reflective backing; the cover T/30 may comprise a membrane layer; the light-transmissive layer 30 of the cover T/30 may comprise a light-guide layer/film/membrane; the cover T/30 may comprise a photo guide. The cover T/30 may comprise a coating and/or a PVD coating and/or a light-transmissive coating and/or a coating at the exterior surface and/or a protective layer and/or a transparent protective layer; the cover T/30 may comprise a decorative layer DL and/or a decorative layer DL configured to provide the decorative effect; the cover T/30 may comprise a luminescent cover and/or a luminescent cover configured to provide the light effect; the cover T/30 may be formed on the substrate SB/20 and/or molded on the substrate SB/20 and/or injection-molded on the substrate SB/20 and/or bonded on the substrate SB/20; the composite structure CS may comprise an adhesive layer between the cover T and the substrate SB/20; the light-transmissive layer 30 may comprise a light transmissive material and/or a light-guide layer and/or a light guiding film and/or a light guide film; the cover T/30 may comprise a backing layer and/or a light-reflective layer and/or a light-reflective material and/or a light reflective surface and/or a light-emitting surface and/or a cover T/30 surface and/or a translucent surface decorative layer and/or a luminous surface and/or a surface decorative layer DL and/or light-transmissive area and/or alight-transmitting area and/or a generally opaque area and/or a non-light transmitting area and/or a light-transmissive protective layer and/or a generally transparent protective layer and/or a protective layer and/or a light output surface. See also FIGS. 12, 12A-12C, 16, 16A-16C, 17, 17A, 18 and 18A.

According to an exemplary embodiment as shown in FIGS. 2, 2A-2C, 3, 3A, 4, 4A, 5, 5A-5C and 6, the component C comprising the composite structure configured to provide the visual effect comprising a light effect and decorative effect at the surface of cover T may comprise a console and/or a panel and/or a trim component C and/or an instrument panel and/or a door panel and/or a floor console and/or an overhead console; the component C may comprise a luminous component and/or a light-emitting component and/or a decorative trim component and/or an illuminated trim component. See also FIGS. 12, 12A-12C, 16, 16A-16C, 17, 17A, 18 and 18A.

### Exemplary Embodiments—B

According to an exemplary embodiment as shown schematically in the FIGURES, a component for a vehicle interior may be configured to transmit light from a light source into the vehicle interior; the component may comprise a composite structure comprising a substrate and a cover and a set of features; the cover may comprise a light-transmissive layer and an exterior surface; the set of features may be configured to direct light from the light source within the light-transmissive layer of the cover toward the exterior surface of the cover; the composite structure may be configured to present a visual effect at the cover; the visual effect may comprise a light effect by light from the light source. The visual effect may comprise a decorative effect from the composite structure; the decorative effect may be provided by a decorative material of the composite structure; the decorative effect may be provided by a decorative layer of the composite structure; the decorative effect may be provided by a decorative material at the cover of the composite structure; the decorative effect may be provided by a decorative layer at the cover of the composite structure; the visual effect may comprise the light effect and/or the decorative effect; the visual effect may comprise the light effect and the decorative effect; the visual effect may comprise the decorative effect when no light may be provided; the visual effect may comprise the decorative effect when no light may be provided there may be no light effect.

According to an exemplary embodiment as shown schematically in the FIGURES, a component for a vehicle interior may be configured to transmit light from a light source into the vehicle interior; the component may comprise a composite structure comprising a substrate and a cover and a set of features; the cover may comprise a light-transmissive layer and an exterior surface; the set of features may be configured to direct light from the light source within the light-transmissive layer of the cover toward the exterior surface of the cover; the composite structure may be configured to present a visual effect at the cover; the visual effect may comprise a light effect by light from the light source. The composite structure may be configured to present the visual effect at the cover; the composite structure may be configured to present the visual effect on the cover; the composite structure may be configured to present the visual effect on and/or in the cover; the composite structure may be configured to present the visual effect on and/or within the cover; the composite structure may be configured to present the visual effect at the exterior surface of the cover; the composite structure may be configured to present the light effect on the cover; the composite structure may be configured to present the light effect on and/or in the cover; the composite structure may be configured to present the light effect on and/or within the cover; the composite structure may be configured to present the light effect at the exterior surface of the cover.

According to an exemplary embodiment as shown schematically in the FIGURES, a component for a vehicle interior may be configured to transmit light from a light source into the vehicle interior; the component may comprise a composite structure comprising a substrate and a cover and a set of features; the cover may comprise a light-transmissive layer and an exterior surface; the set of features may be configured to direct light from the light source within the light-transmissive layer of the cover toward the exterior surface of the cover; the composite structure may be configured to present a visual effect at the cover; the visual effect may comprise a light effect by light from the light source. The set of features of the composite structure may be configured to present the light effect on the cover; the set of features of the composite structure may be configured to present the light effect on and/or in the cover; the set of features of the composite structure may be configured to present the light effect on and/or within the cover; the set of features of the composite structure may be configured to present the light effect at the exterior surface of the cover; the visual effect may comprise an image; the light effect may comprise an image; the image may comprise an icon; the image may comprise a pattern; the image may comprise information; the image may comprise a pattern; the pattern may comprise the set of features; the pattern may comprise the image.

According to an exemplary embodiment as shown schematically in the FIGURES, a component for a vehicle interior may be configured to transmit light from a light source into the vehicle interior; the component may comprise a composite structure comprising a substrate and a cover and a set of features; the cover may comprise a light-transmissive layer and an exterior surface; the set of features may be configured to direct light from the light source within the light-transmissive layer of the cover toward the exterior surface of the cover; the composite structure may be configured to present a visual effect at the cover; the visual effect may comprise a light effect by light from the light source. Light from the light source may be configured to present the light effect at the exterior surface of the cover; the set of features may be configured to present the image at the exterior surface of the cover; the set of features may comprise a pattern configured to present the image at the exterior surface of the cover; the set of features may comprise an arrangement configured to present the image at the exterior surface of the cover; the set of features may be configured to direct light from the light source within the light-transmissive layer of the cover and to reflect light toward the exterior surface of the cover; the set of features may be configured to direct light from the light source within the light-transmissive layer of the cover and to reflect and/or refract light toward the exterior surface of the cover; the set of features may be configured to reflect and/or refract light from the light source within the light-transmissive layer of the cover and to reflect and/or refract light toward the exterior surface of the cover; the set of features may be configured to reflect and/or scatter light from the light source within the light-transmissive layer of the cover and to reflect and/or scatter light toward the exterior surface of the cover; the set of features may be configured to direct and/or scatter light from the light source within the light-transmissive layer of the cover and to direct and/or scatter light toward the exterior surface of the cover; the set of features may be configured to direct light from the light source within the light-transmissive layer of the cover and to direct light toward the exterior surface of the cover to provide the light effect; the set of features may be configured to direct light from the light source within the light-transmissive layer of the cover and to direct light toward the exterior surface of the cover to provide the image.

According to an exemplary embodiment as shown schematically in the FIGURES, a component for a vehicle interior may be configured to transmit light from a light source into the vehicle interior; the component may comprise a composite structure comprising a substrate and a cover and a set of features; the cover may comprise a light-transmissive layer and an exterior surface; the set of features may be configured to direct light from the light source within the light-transmissive layer of the cover toward the exterior surface of the cover; the composite structure may be configured to present a visual effect at the cover; the visual effect may comprise a light effect by light from the light source. The light effect may comprise a color effect; the light effect may comprise a multi-color effect; the light effect may comprise a dynamic effect; the light effect may comprise a multi-layer effect; the light effect may comprise a three-dimensional effect; the light effect may comprise luminance; the light effect may comprise directed light; the light effect may comprise reflected light; the light effect may comprise scattered light; the light effect may comprise reflected light and/or refracted light; the visual effect may comprise a decorative effect from the composite structure; the decorative effect may be provided by a decorative material of the composite structure; the decorative effect may be provided by a decorative layer of the composite structure; the decorative effect may comprise a texture; the decorative effect may comprise a grain; the decorative effect may comprise a color; the decorative effect may comprise a surface effect; the decorative effect may comprise a surface effect at the exterior surface of the cover; the visual effect may comprise a depth effect; the light source may comprise a lamp; the light source may comprise an LED; the light source may comprise an LED arrangement; the light source may comprise a side light; the light source may comprise a light module; the light module may comprise a light guide; the light module may comprise a color light source; the light module may comprise a multi-color light source; the light module may comprise a multi-layer light source; the light module may comprise a multi-layer light guide; the light module may comprise an outlet for light; the light source may comprise an outlet for light; the outlet for light may comprise an aperture; the outlet for light may comprise a set of apertures; light from the light source may be directed into the composite structure; light from the light source may be directed into the cover of the composite structure; an interface may be provided between the light source and the composite structure; the interface may comprise a surface on the composite structure; the interface may comprise a surface on an edge of the cover of the composite structure; light may be transmitted from the light source through the interface to the composite structure; light may be transmitted from the light source through the interface to the cover of the composite structure.

According to an exemplary embodiment as shown schematically in the FIGURES, a component for a vehicle interior may be configured to transmit light from a light source into the vehicle interior; the component may comprise a composite structure comprising a substrate and a cover and a set of features; the cover may comprise a light-transmissive layer and an exterior surface; the set of features may be configured to direct light from the light source within the light-transmissive layer of the cover toward the exterior surface of the cover; the composite structure may be configured to present a visual effect at the cover; the visual effect may comprise a light effect by light from the light source. The cover may comprise a light-guide layer; the light-transmissive layer may comprise a light-guide layer; the substrate may comprise the set of features; the cover may comprise the set of features; the set of features may be on the substrate; the set of features may be under the cover; the substrate may comprise a substrate/matrix comprising the set of features; the cover may comprise a substrate/matrix comprising the set of features; the set of features may between the substrate and the cover; the composite structure may comprise a substrate/matrix comprising the set of features; the set of features may be within the matrix; the set of features may comprise at least one feature; the set of features may comprise at least one projection; the set of features may comprise a pattern of features; the set of features may comprise a pattern of features configured to present the image; the set of features may comprise a pattern of projections configures to present the image; the set of features may comprise at least one recess; the set of features may comprise a set of recesses; a feature of the set of features may comprise a projection; a feature of the set of features may comprise a recess; the set of features may comprise a set of projections; the set of projections may comprise a pattern of projections; the set of projections may comprise a row of projections; the set of features may comprise a set of dots; the set of features may comprise a set of dots of deposited material; the set of features may comprise a uniform set of features; the set of features may comprise a set of applied features; the set of features may comprise a set of deposited features; the set of features may comprise a set of printed features; the set of features may comprise a set of formed features; the set of features may comprise a set of molded features; the set of features may comprise a set of rounded features; the set of features may comprise a set of curved features; the set of features may comprise a set of curved-shaped features; the set of features may comprise a set of block-shaped features; the set of features may comprise a set of flat-sided features; the set of features may comprise a set of bumps; the set of features may comprise a set of blocks; the set of features may comprise a set of optically-reflecting features; the set of features may comprise a set of structures; the set of features may comprise a set of optically-reflecting structures; the set of features may comprise a set of optical features; the set of features may comprise a set of optically-reflecting features in a pattern; the set of features may comprise a set of optical structures in a pattern; the set of features may comprise a pattern of features; the set of features may be configured to reflect light from within the light-transmissive layer of the cover through the exterior surface of the cover; the set of features may be formed at the cover; the set of features may be formed in the cover; the set of features may be formed into the cover; the set of features may comprise a set of optical microstructures in a pattern formed at the cover; the set of features may comprise formed by embossing and/or micro-nano embossing and/or printing and/or screen printing and/or imprinting and/or ultraviolet imprinting and/or etching and/or engraving.

According to an exemplary embodiment as shown schematically in the FIGURES, a component for a vehicle interior may be configured to transmit light from a light source into the vehicle interior; the component may comprise a composite structure comprising a substrate and a cover and a set of features; the cover may comprise a light-transmissive layer and an exterior surface; the set of features may be configured to direct light from the light source within the light-transmissive layer of the cover toward the exterior surface of the cover; the composite structure may be configured to present a visual effect at the cover; the visual effect may comprise a light effect by light from the light source. The cover may comprise a membrane layer; the light-transmissive layer of the cover may comprise a light-guide layer; the cover may comprise a photo guide; the cover may comprise a cover assembly; the cover may comprise a multi-layer assembly; the cover may comprise a film; the cover may comprise a film material; the cover may comprise a film layer; the cover may comprise at least one film layer; the cover may comprise multi-film layer; the cover may comprise a cover layer; the cover may comprise a single layer; the cover may comprise a multi-layer cover; the cover may comprise a molded layer; the cover may comprise a multi-layer molded cover; the cover may comprise a backing layer; the cover may comprise a backing; the cover may comprise a reflective backing; the cover may comprise a coating; the cover may comprise a PVD coating; the cover may comprise a light-transmissive coating; the cover may comprise a coating at the exterior surface; the cover may comprise a protective layer; the cover may comprise a transparent protective layer; the cover may comprise a decorative layer; the cover may comprise a decorative layer configured to provide the decorative effect; the cover may comprise a luminescent cover; the cover may comprise a luminescent cover configured to provide the light effect; the cover may be formed on the substrate; the cover may be molded on the substrate; the cover may be injection-molded on the substrate; the cover may be bonded on the substrate; the composite structure may comprise an adhesive layer between the cover and the substrate.

According to an exemplary embodiment as shown schematically in the FIGURES, a component for a vehicle interior may be configured to transmit light from a light source into the vehicle interior; the component may comprise a composite structure comprising a substrate and a cover and a set of features; the cover may comprise a light-transmissive layer and an exterior surface; the set of features may be configured to direct light from the light source within the light-transmissive layer of the cover toward the exterior surface of the cover; the composite structure may be configured to present a visual effect at the cover; the visual effect may comprise a light effect by light from the light source. The set of features may be formed onto the substrate; the set of features may be formed on the substrate; the substrate may comprise a base layer; the substrate may comprise a panel; the substrate may comprise a carrier; the substrate may comprise a plate; the substrate may comprise a base; a feature of the set of features may comprise at least one of a structure and/or a micro-structure and/or an optical micro-structure and/or a deposited material and/or a dot and/or a projection and/or a formed projections and/or a recess; the set of features may comprise a layer and/or a pattern and/or a preset pattern and/or a matrix; the light-transmissive layer may comprise a light transmissive material and/or a light-guide layer and/or a light guiding film and/or a light guide film; the cover may comprise a backing layer and/or a light-reflective layer and/or a light-reflective material and/or a light reflective surface and/or a light-emitting surface and/or a cover surface and/or a translucent surface decorative layer and/or a luminous surface and/or a surface decorative layer and/or light-transmissive area and/or a light-transmissive area and/or a generally opaque area and/or a non-light transmitting area and/or a light-transmissive protective layer and/or a generally transparent protective layer and/or a protective layer and/or a light output surface; the composite structure may comprise the light source; the composite structure may comprise an interface between the light source and the cover; the composite structure may comprise an optical coupling between the light source and the cover; the component may comprise a luminous component; the component may comprise a light-emitting component; the component may comprise a console and/or a panel and/or a trim component and/or an instrument panel and/or a door panel and/or a floor console and/or an overhead console.

According to an exemplary embodiment as shown schematically in the FIGURES, a component for a vehicle interior configured to transmit light from a light source into the vehicle interior may comprise a composite structure comprising a substrate and a cover and a set of features; the cover may comprise a light-transmissive layer and an exterior surface; the set of features is configured to direct light from the light source within the light-transmissive layer of the cover toward the exterior surface of the cover; the composite structure is configured to present a visual effect at the cover; the visual effect may comprise a light effect by light from the light source. The visual effect may comprise a decorative effect from the composite structure. The composite structure may be configured to present the visual effect on, in the cover, within the cover; the visual effect may comprise the light effect, the decorative effect. The composite structure may comprise an interface between the light source and the cover. The set of features of the composite structure is configured to present the light effect at the exterior surface of the cover. The light effect may comprise an image, a pattern; the pattern may comprise the set of features; the set of features may comprise an arrangement configured to present the image at the exterior surface of the cover. The light effect may comprise a color effect, a multi-color effect, a dynamic effect, a multi-layer effect, a three-dimensional effect. The light effect may comprise illumination, luminesce, directed light, scattered light, reflected light, refracted light. The set of features is configured to direct light from the light source within the light-transmissive layer of the cover and to reflect light toward the exterior surface of the cover. The component may comprise a console, a panel, a trim component, an instrument panel, a door panel, a floor console, and/or an overhead console.

### Exemplary Embodiments—C

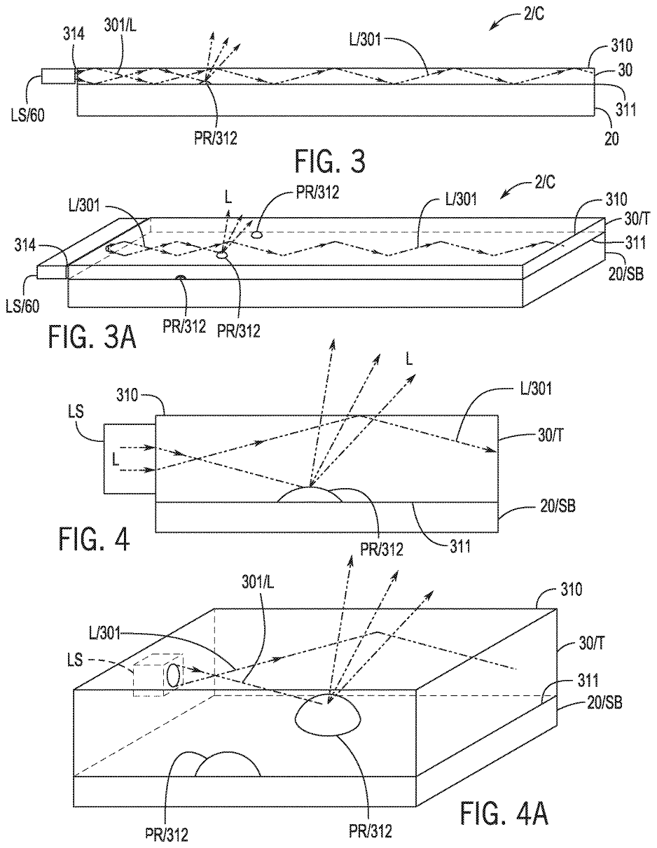

According to an exemplary embodiment as shown schematically in FIGS. 1 and 2, vehicle 1 may comprise component C/2 such as the instrument panel 10, the roof 11 and the door panel 12. The component C/2 may comprise a composite structure CS; the component with composite structure CS may provide a luminous trim/component C/2 for the vehicle; the component C/2 may be configured to provide an illuminated interior trim display to provide a light effect. See FIGS. 3 to 15.

According to an exemplary embodiment as shown schematically in FIG. 3, the luminous trim/component C/2 comprises a substrate SB/20 and a cover comprising light-transmissive/guide layer T/30 attached to the substrate SB/20 to provide a substrate/matrix for the composite structure; substrate SB/20 may be the backplate of the luminous trim/component C/2 to carry and protect the cover/light guide layer/film 30. According to an exemplary embodiment as indicated schematically in the FIGURES, the substrate/matrix may comprise the internal trim component C/2.

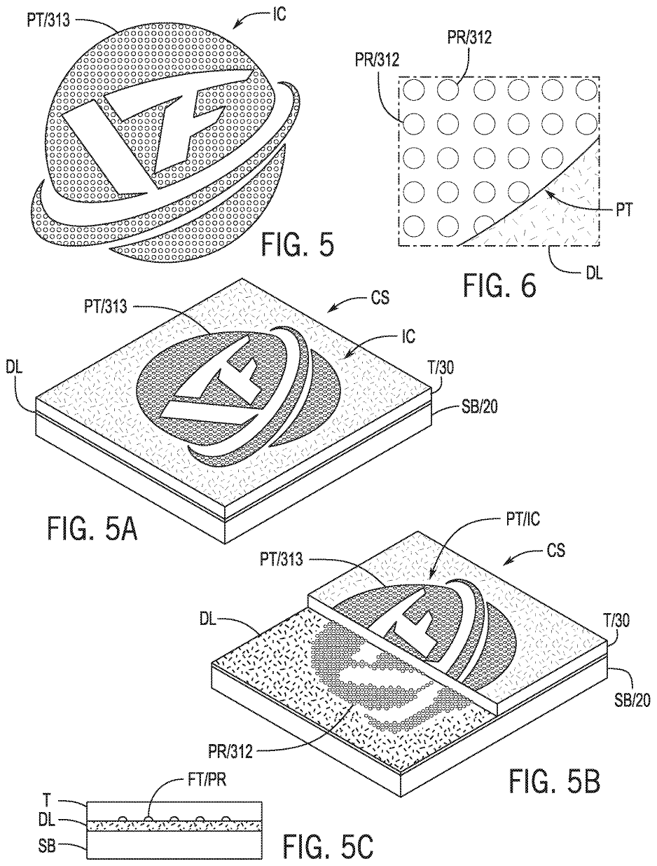

The cover comprising light-transmissive/guide layer T/30 comprises the light output surface 310 and the bottom surface 311 opposite the light output surface 310. Bottom 311 near substrate/matrix 20. Multiple optical microstructures 312 are constructed in at least part of the light-guiding film 30. According to an exemplary embodiment as shown schematically in FIG. 5 and FIG. 6, these optical microstructures 312 are arranged in a preset pattern 313.

When using the luminous trim/component C/2 of the present application, as shown in FIG. 4, the light L/301 propagating in the cover comprising light-transmissive/guide layer T/30 passes through these optical microstructures 312 and changes the direction of propagation and emits from the light emitting surface 310, so that the cover comprising light-transmissive/guide layer T/30 presents a preset pattern 313. The remainder of the light L/301 still travels within the cover comprising light-transmissive/guide layer T/30 and does not eject from the light emitting surface 310. According to an exemplary embodiment as indicated schematically, on the light surface 310, except for the area corresponding to the preset pattern 313, there is almost no emitted light in the remainder of the area, which makes the pattern clear and sharp. According to an exemplary embodiment as indicated schematically, the luminous trim/component C/2 eliminates the need for a shield plate and homogenized film with a hollow pattern as in the prior art, which reduces the number of laminated sheets used by the luminous trim/component C/2, thereby helping to reduce the thickness of the luminous trim/component C/2 (for example, the luminous trim/component C/2 may be constructed to between 1.8 mm and 3.6 mm thick) for easy use in the illuminated trim 2 in tight spaces. Moreover, the structure of the luminous ornament 2 of the present application is simpler; the arrangement is configured to reduce the cost.

According to an exemplary embodiment as indicated schematically, the thickness of the cover comprising light-transmissive/guide layer T/30 of the light-emitting trim 2 of the present application is smaller than that of the light guide plate in the prior art. As indicated schematically, the thickness of the light guide plate is usually greater than or equal to 2 mm, and the thickness of the light guide layer T/30 of the present application is less than or equal to 1 mm, for example, 0.6 mm; the arrangement is configured to reduce the thickness of the luminous trim/component C/2.

According to an exemplary embodiment as indicated schematically, the cover comprising light-transmissive/guide layer T/30 is well known to an arrangement according to an exemplary embodiment. Optical microstructure 312 refers to a structure that affects the transmission performance of light at the scale of light wavelength or sub-optical wavelength. According to an exemplary embodiment as indicated schematically in the FIGURES, the optical microstructure 312 may be formed in a variety of ways within the light guide layer T/30 and close to the bottom surface 311, for example, by nanoimprinting or micro-imprinting, or by screen printing, etching, engraving, etc. According to an exemplary embodiment as indicated schematically in the FIGURES, the optical microstructure 312 may be formed in other locations within the light guide layer 30, such as near the light outlet surface 310. When using the light guide layer 30, when the light does not encounter the optical microstructure 312 and will propagate in the light guide layer T/30 in a total reflection manner. After encountering the optical microstructure 312, reflection of light is emitted from the light surface 310.

FIG. 12A schematically shows the cover comprising light-transmissive/guide layer fabricated by micro-nano imprinting. In the manufacturing process, the flexible/support substrate 321 is first supplied. Multiple pits 322 are then formed on the surface of the flexible/support substrate 321 by micro-nano imprinting. Each pit 322 is used as the optical microstructure and a plurality of pit 322 constitutes a preset pattern. The method of making light guide films by etching or engraving may be used according to an exemplary embodiment.

FIG. 12B schematically shows the cover comprising light-transmissive/guide layer manufactured by screen printing. In the manufacturing process, the flexible/support substrate 321 is first supplied. Then, the ink 323 is printed on the surface of the flexible/support substrate 321 by screen printing. Ink 323 is used as the optical microstructure described above and forms a preset pattern.

FIG. 12C schematically shows the cover comprising light-transmissive/guide layer fabricated by UV imprinting. In the manufacturing process, the flexible/support substrate 321 is first supplied. Then, an ultraviolet adhesive layer 324 is applied to at least one area of one surface of the flexible/support substrate 321, and the UV adhesive layer 324 is cured. Next, micro-nano imprinting is performed on the cured UV layer 324 to form multiple pits 322 on the UV layer 324. Each pit 322 is used as the optical microstructure; a plurality of pit 322 constitutes a preset pattern. According to an exemplary embodiment as indicated schematically, in the light guide layer manufactured by ultraviolet imprinting, the light guide layer comprises a flexible/support substrate 321 and an ultraviolet adhesive layer 324 attached to the flexible/support substrate 321, and a preset pattern is formed on the UV adhesive layer 324. According to an exemplary embodiment as indicated schematically, other types of optical adhesive layers may be applied to the flexible/support substrate 321 in appropriate cases, and on this optical adhesive layer pits are formed for optical microstructures.

According to an exemplary embodiment as indicated schematically in the FIGURES, the cover comprising light-transmissive/guide layer T/30 may be attached to the substrate SB/20 by means of insert injection molding, using optical glue bonding, hot melt embedding screws, laser welding, etc. For insert injection molding, the light guide layer T/30 may be used as the insert, and the substrate/matrix SB/20 is injected on the underside of the light guide layer 311 to form a substrate/matrix 20.

According to an exemplary embodiment as indicated schematically in the FIGURES, the cover comprising light-transmissive/guide layer T/30 is tightly attached to the substrate SB/20 (e.g., by means of an optical adhesive to the substrate 20). According to an exemplary embodiment as indicated schematically, the light guide layer T/30 forms a whole with the substrate/matrix SB/20 to avoid the relative movement of the light guide layer T/30 relative to the substrate/matrix 20, and then avoid mutual wear between the light guide layer T/30 and the substrate/matrix SB/20 or the abnormal noise of the luminous trim/component C/2.

According to an exemplary embodiment as indicated schematically in the FIGURES, there may be a gap between the light guide layer T/30 and the substrate/matrix 20, and the light guide layer T/30 is connected to the substrate/matrix SB/20 only at some pre-selected positions (e.g., it may be connected by laser welding); the arrangement is configured to simplify the fabrication of the luminous trim/component C/2.

According to an exemplary embodiment as indicated schematically, as shown in FIG. 7, a first reflective layer 302 is set between the substrate SB/20 and the cover comprising light-transmissive/guide layer 30. The first reflection layer 302 reflects the light leakage 303 generated at the optical microstructure 312 towards the substrate/matrix SB/20 (or the first reflection layer 302) into the light guide membrane 30, and these light rays are finally emitted from the light emitting surface 310. According to an exemplary embodiment as indicated schematically, the brightness of the pattern presented by the light guide layer T/30 will be significantly improved, improving the clarity of the pattern.

According to an exemplary embodiment as indicated schematically in the FIGURES, the first reflective layer 302 may be formed on the bottom surface 311 of the cover comprising light-transmissive/guide layer T/30 or on the corresponding surface of the substrate 20. An appropriate reflective material may be selected (e.g., reflective material may be reflective ink) based on the final brightness of the desired pattern. According to an exemplary embodiment as indicated schematically in the FIGURES, PVD (physical vapor deposition), spraying, or other appropriate processes may be used to form a first reflective layer on the bottom surface of the light guide layer 311 or on the corresponding surface of the substrate/matrix 20, which is not restricted here.

According to an exemplary embodiment as indicated schematically, in the case that the substrate/matrix SB/20 has good reflective properties (for example, when the substrate/matrix SB/20 is white), the surface of the substrate/matrix SB/20 in contact with the light-guiding film T/30 may be used as the first reflective layer 302. According to an exemplary embodiment as indicated schematically, the Illuminated Trim 2 no longer needs to be equipped with a separate first reflection layer.

According to an exemplary embodiment as indicated schematically, as shown in FIG. 8, the luminous trim/component C/2 may comprise a light-transmitting surface finish layer 40. The surface decoration layer 40 is provided at the light output surface 310 of the light guide layer 30. As indicated schematically, the surface finish layer 40 acts as a protection against the light guide layer T/30 from being damaged (e.g., scratched) and affecting the quality of the displayed pattern.

According to an exemplary embodiment as indicated schematically in the FIGURES, the surface finish layer 40 is translucent. As indicated schematically, the arrangement of surface decoration layer 40 will act as an obscuration of the internal components of the luminous trim/component C/2, so as to prevent the user from observing the internal components of the luminous trim/component C/2 from the outside through the surface decoration layer 40; the arrangement is configured to improve the aesthetics of the luminous decoration 2. According to an exemplary embodiment as indicated schematically, the user may still identify the pattern presented by the light guide layer T/30 through this surface decoration layer 40.

According to an exemplary embodiment as indicated schematically in the FIGURES, the light transmittance of the surface finish layer 40 is between 5 percent and 95 percent, and the haze is between 0.5 and 90. By making the surface decoration layer 40 have appropriate light transmittance and haze, the surface decoration layer 40 may block the internal components of the luminous decoration 2; the user may still identify the pattern presented by the light guide layer 30 through the surface decoration layer 40, so that the surface decoration layer 40 forms a translucent. As indicated schematically, the surface modification layer 40 may have high light transmittance but large haze (e.g., light transmittance is 80 percent, haze is 80 percent; The surface decoration layer 40 may have a lower light transmittance and lower light transmittance; the haze is small (e.g., the light transmittance is SB/20 percent, the haze is 1 percent), and these surface decoration layers 40 may achieve the above effect. According to an exemplary embodiment as indicated schematically, if desired, a light-transmitting zone corresponding to the preset pattern may be formed on the surface finish layer 40; the remainder of the area is blackened out so that the user may observe a clear pattern.

According to an exemplary embodiment as indicated schematically in the FIGURES, the surface finish layer 40 is closely attached to the light output surface 310. According to an exemplary embodiment as indicated schematically, the pattern on the glossy surface 310 seen by the user through the surface finish layer 40 is clearer and the boundaries are sharp. As indicated schematically, the arrangement is preferred for the central control lights and instrument lights of vehicle 1.

According to an exemplary embodiment as indicated schematically in the FIGURES, there is a gap between the surface finish layer 40 and the light output surface 310. According to an exemplary embodiment as indicated schematically, the pattern on the glossy surface 310 that the user sees through the surface finish layer 40 becomes larger and the borders are softer. As indicated schematically, the arrangement is preferred for ambient lighting in vehicle 1. According to an exemplary embodiment as indicated schematically in the FIGURES, the gap may be greater than 0 mm and less than or equal to 3 mm. As indicated schematically, the gap may be set to other values according to an exemplary embodiment. According to an exemplary embodiment as indicated schematically, in the case of a gap between the surface finish layer 40 and the light output surface 310, the surface finish layer 40 may be connected to the cover comprising light-transmissive/guide layer T/30 only at some pre-selected points (e.g., by laser welding).

According to an exemplary embodiment as indicated schematically in the FIGURES, the surface finish layer 40 may be made using a light-transmitting material with a specific tactile feel to give the luminous trim/component C/2 a specific tactile feel. As indicated schematically, the surface finish layer 40 may be made of translucent leather, which gives the luminous trim/component C/2 a leather-like feel. According to an exemplary embodiment as indicated schematically in the FIGURES, the surface finish layer 40 may be made using a light-transmitting material with a pattern to make the luminous trim/component C/2 meet specific pattern requirements. As indicated schematically, the surface finish layer 40 may be made using light-transmitting wood or a light-transmitting flexible/support with a preset pattern, etc. As indicated schematically, the surface finish layer 40 may be made of any other appropriate light-transmitting material as needed, and there are no restrictions here.

According to an exemplary embodiment as indicated schematically in the FIGURES, a foam with high light transmission may be set between the surface finish layer 40 and the light output surface 310. As indicated schematically, the arrangement gives the luminous trim/component C/2 a soft touch. According to an exemplary embodiment as indicated schematically, foam may cause the observed pattern to be unclear. According to an exemplary embodiment as indicated schematically, it is possible to form a light transmission zone corresponding to the preset pattern on the surface finish layer 40; the remainder of the area is blacked out so that the user may observe a clear pattern.

According to an exemplary embodiment as indicated schematically, as shown in FIG. 9, the luminous trim/component C/2 may comprise the underside trim layer 50. The bottom modification layer 50 is between the cover comprising light-transmissive/guide layer T/30 and the substrate/matrix 20. As indicated schematically, the underside finish layer 50 may be made using materials with patterns and/or colors (e.g., flexible/supports with patterns and/or colors). Since the light guide layer T/30 is transparent, the user may directly observe the pattern and/or color on the underside finish layer 50 from the outside of the luminous trim/component C/2, and the user may not even be aware of the presence of a light guide layer 30, thus achieving the effect of hiding the light guide layer 30.

According to an exemplary embodiment as indicated schematically, in the technical scheme shown in FIG. 9, the luminous trim/component C/2 may comprise a transparent protective layer (not shown in the figure). As indicated schematically, the arrangement protective layer is covered on the light emitting surface 310 of the light guide layer 30. The protective layer is used to avoid damage to the light guide layer 30. As indicated schematically, in the case of light guide layer T/30 made of PC (polycarbonate), its hardness is HB level. When the light emitting surface 310 of the light guide layer 30 is used as the surface of the luminous trim/component C/2, this hardness level may not meet the requirements. According to an exemplary embodiment as indicated schematically, a protective layer is applied to the glossy surface 310. According to an exemplary embodiment as indicated schematically in the FIGURES, the protective layer may be a transparent hardened coating, or a transparent PC sheet, etc.

According to an exemplary embodiment as indicated schematically, a protective layer may be applied to the light output surface 310 if the hardness level of the light guide layer T/30 meets the requirements. According to an exemplary embodiment as indicated schematically, the pattern formed on the light output surface 310 may be avoided from color casting, light loss, etc.; the arrangement is configured to improve the brightness and clarity of the pattern.

FIG. 10 schematically shows another structure of luminous trim/component C/2, where the luminous trim/component C/2 has multiple layers of light-guiding film (e.g., the first layer 30a, the second layer 30b, and the third layer 30c). The first layer 30a, the second layer 30b and the third layer 30c are stacked.

According to an exemplary embodiment as indicated schematically in the FIGURES, the preset patterns on the first layer 30a, the second layer 30b and the third layer 30c may be different from each other. According to an exemplary embodiment as indicated schematically, according to different needs, light may be selected to shine into one or more of these film layers, so that the luminous ornament 2 may show different patterns, which is convenient for the user to use. According to an exemplary embodiment as indicated schematically, by circulating light into each layer, the luminous ornament 2 may display a dynamic luminous effect to meet the needs of the user. According to an exemplary embodiment as indicated schematically, according to an exemplary embodiment, the luminous ornament 2 may be constructed with only two layers of cover comprising light-transmissive/guide layer or more than three layers of light guide film. According to an exemplary embodiment as indicated schematically, as shown in FIG. 10, the first layer 30a, the second layer 30b, and the third layer 30c are set in the direction perpendicular to these layers (direction Z as shown in FIG. 10), and the preset pattern formed by the optical microstructure 312 on each layer deviates from the preset pattern formed by the optical microstructure 312 on the remaining layer (i.e., does not overlap each other). As indicated schematically, when light is injected into any two or all of the first layer 30a, the second layer 30b, and the third layer 30c, the patterns on the luminous surface of each layer do not overlap and may be combined into different patterns to provide an arrangement for the use of luminous decorations 2.

According to an exemplary embodiment as indicated schematically in the FIGURES, the preset pattern on the first layer 30a, the second layer 30b and the third layer 30c is the same. According to an exemplary embodiment as indicated schematically, the first layer 30a, the second layer 30b, and the third layer 30c may be set to overlap each other along the direction perpendicular to these layers (direction Z as shown in FIG. 10), and the preset patterns formed by the optical microstructures 312 on these layers overlap each other. According to an exemplary embodiment as indicated schematically, depending on the need, light may be selected to shine into one or more of these layers, thus controlling the brightness of the final pattern of the luminous trim/component C/2.

According to an exemplary embodiment as indicated schematically in the FIGURES, the light entering into different layers is of different colors. As indicated schematically, the arrangement allows you to control the color of the final pattern of the luminous trim/component C/2/C by selecting the light that shines into one or more of these layers.

According to an exemplary embodiment as indicated schematically, regardless of whether the preset patterns on the first layer 30a, the second layer 30b, and the third layer 30c are the same or different, the first layer 30a, the second layer 30b, and the third layer 30c may be set to follow the direction perpendicular to these layers (direction Z as shown in FIG. 10)), the preset pattern formed by the optical microstructure 312 on each film layer deviates from the preset pattern formed by the optical microstructure 312 on the remaining film layer. According to an exemplary embodiment as indicated schematically, when light is injected into any two or all of the first layer 30a, the second layer 30b, and the third layer 30c, the light emitted from the light output surface of each layer does not overlap and may be combined into different patterns. According to an exemplary embodiment as indicated schematically in the FIGURES, the first layer 30a, the second layer 30b, and the third layer 30c may be set to follow the direction perpendicular to these layers (direction Z shown in FIG. 10), and the preset pattern formed by the optical microstructure 312 on each layer overlaps at least partially with the preset pattern formed by the optical microstructure 312 on the remaining layers. According to an exemplary embodiment as indicated schematically, when light is injected into any two or all of the first layer 30a, the second layer 30b, and the third layer 30c, the patterns on the luminous surface of these layers are superimposed on each other, thus combining into a wider variety of different patterns to provide an arrangement for the use of luminous decorations 2.

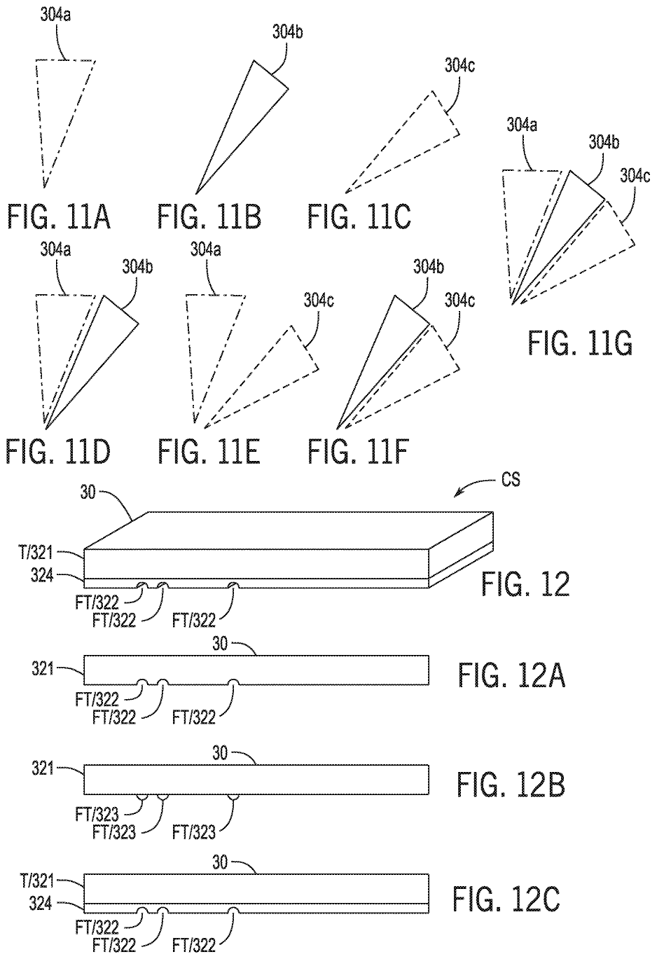

FIG. 11A to FIG. 11G show the display effect of the luminous trim/component C/2 shown in FIG. 10. When only light is injected into the first layer T/30 a, the light is directed by the optical microstructure 312 of the first layer T/30 A and emitted from the light emitting surface, causing the luminous ornament 2 to show the first pattern 304a (as shown in FIG. 11A). When the light is injected into the second layer 30b only, the light is directed by the optical microstructure 312 of the second layer 30b and ejects from the light emitting surface 30a (and deviates from the optical microstructure 312 of the first layer 30a), causing the luminous decoration 2 to show the second pattern 304b (as shown in FIG. 11B). According to an exemplary embodiment as indicated schematically, when light is only injected into the third layer 30C, the luminous ornament 2 shows the third pattern 304c (as shown in FIG. 11C). When light is injected into the first layer 30a and the second layer 30b at the same time, the luminous ornament 2 shows the first pattern 304a and the second pattern 304b at the same time (as shown in FIG. 11D). When light is injected into the first layer 30A and the third layer 30c at the same time, the luminous ornament 2 shows the first pattern 304a and the third pattern 304c at the same time (as shown in FIG. 11E). When light is emitted into the second layer 30b and the third layer 30c at the same time, the luminous ornament 2 shows the second pattern 304b and the third pattern 304c at the same time (as shown in FIG. 11F). When light is injected into the first layer 30a, the second layer 30b and the third layer 30c at the same time, the luminous ornament 2 shows the first pattern 304a, the second pattern 304b and the third pattern 304c at the same time (as shown in FIG. 11G). When the light is circulated into the first layer 30a, the second layer 30b, and the third layer 30c, the luminous ornament 2 will display the first pattern 304a, the second pattern 304b, and the third pattern 304c in a cycle, and the illuminated ornament 2 shows a dynamic luminous effect as a whole. As indicated schematically, according to an exemplary embodiment, you may choose to shine light into any or more of the first layer 30a, the second layer 30b, and the third layer 30c to make the illuminated decoration 2 display the required pattern.

According to an exemplary embodiment as indicated schematically in the FIGURES, as shown in FIG. 10, between the first layer 30a and the second layer 30b, and between the second layer 30b and the third layer 30c, a transparent binder 305 is filled. According to an exemplary embodiment as indicated schematically, the first layer 30a, the second layer 30b and the third layer 30c are bonded into a whole by binder 305 so that these layers do not move relatively. As indicated schematically, the arrangement avoids accidental misalignment of these layers with each other, which in turn prevents the pattern displayed by the luminous trim/component C/2 from being distorted or displaying the wrong pattern. According to an exemplary embodiment as indicated schematically, these layers are bonded into a single whole, which avoids abnormal noises caused by these layers wearing each other or luminous trims 2. According to an exemplary embodiment as indicated schematically, binder 305 does not affect the propagation of light within the film layer and allows light to pass through the optical microstructure 312 and then change the direction of propagation to pass through. According to an exemplary embodiment as indicated schematically in the FIGURES, the binder 305 may be any of the optical adhesives (i.e., OCA adhesives), hot melt adhesives, and water-based adhesives; an arrangement according to an exemplary embodiment may fit the layers together according to known methods such as laser welding.

According to an exemplary embodiment as indicated schematically in the FIGURES, there may be gaps between adjacent film layers and they are connected to each other only at some pre-selected locations (e.g., they may be connected by laser welding). As indicated schematically, the arrangement helps simplify the manufacturing of luminous trims 2.

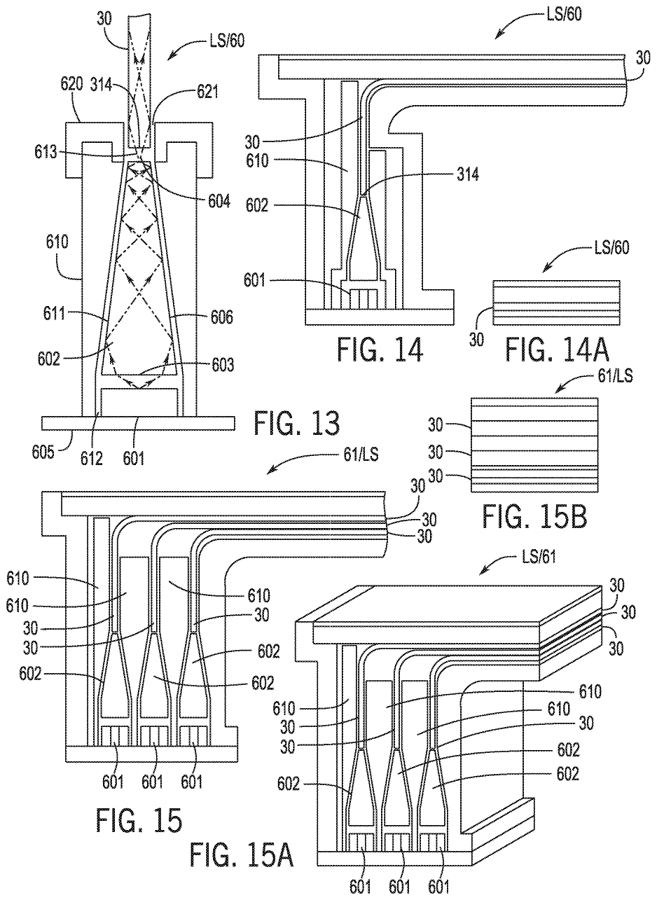

According to an exemplary embodiment as indicated schematically, the illuminated trim 2 may comprise a light source LS/60 (as shown in FIG. 13). The cover comprising light-transmissive/guide layer T/30 may comprise an incident surface 314 connected between the light output surface 310 and the bottom surface 311. The light source LS/60 is set to correspond to the incident plane 314. According to an exemplary embodiment as indicated schematically, the light emitted by the light source LS/60 will shine into the light guide layer 30, so that the luminous ornament 2 displays a pattern corresponding to the preset pattern 313 on the light guide layer 30.

According to an exemplary embodiment as indicated schematically in the FIGURES, in the presence of multiple light guide films 30, an independent light source LS/60 is provided for each light guide layer 30. As indicated schematically, as shown in FIG. 10, each of the first layer 30a, the second layer 30b, and the third layer 30c is equipped with an independent light source 60. As indicated schematically, the arrangement allows each light source to be controlled LS/60 glow or extinguished as needed so that the glowing trim 2 shows the desired pattern.

According to an exemplary embodiment as indicated schematically in the FIGURES, the light source LS/60 may emit colored light; the arrangement is configured to make the luminous ornament 2 present a special pattern effect.

According to an exemplary embodiment as indicated schematically in FIG. 13, the component may comprise a light source LS/60; light source LS/60 comprises a light-emitting device 601 and a concentrator 602. According to an exemplary embodiment as indicated schematically, the light-emitting device 601 is an LED lamp bead. LED lamp beads are small in size for easy application to smaller luminous trims 2. According to an exemplary embodiment as indicated schematically, the LED lamp beads emit and extinguish for easy control to easily achieve the desired pattern of the illuminated ornaments/components 2; the light-emitting device 601 may be used as a laser source. The condenser 602 comprises an incident end 603, an outlet end 604 away from the incident end 603, and a side wall 606 connected between the incident end 603 and the outlet end 604. The luminous device 601 is set to correspond to the incident end 603 of the concentrator 602, and the size of the luminous device 601 matches the size of the incident terminal 603, so as to facilitate the light emitted by the luminous device 601 to enter the concentrator 602. The outlet end 604 of the concentrator 602 corresponds to the incident surface 314 of the light guide membrane 30, and the size of the outlet end 604 matches the size of the incident surface 614, so as to facilitate the light in the concentrator 602 to enter the light guide layer 30. According to an exemplary embodiment as indicated schematically, the condenser 602 allows the light emitted by the light-emitting device 601 to penetrate the light guide layer T/30 as much as possible. It is particularly advantageous to set up a concentrator 302 when the size of the light-emitting device 601 does not match the size of the incident surface 314 of the light-emitting membrane 30. As indicated schematically, if the size of the light-emitting device 601 is larger than the size of the incident surface 314 of the light-emitting membrane 30, then the light-emitting device 602 is generally cone-shaped, and the large end is oriented towards the light-emitting device 601 and the small end is facing the light-emitting membrane 30, so as to direct the light emitted by the light-emitting device 601 into the light-guiding membrane T/30 as much as possible. According to an exemplary embodiment as indicated schematically, the concentrator 602 may not be set up when the size of the light-emitting device 601 matches the size of the incident surface 314 of the light-emitting membrane 30.

According to an exemplary embodiment as indicated schematically in FIG. 13, the component may comprise a light source LS/60 shown as a light box 610. The light box 610 has a containment cavity 611. The first end of the light box 610 is constructed with an assembly opening 612 connected to the containment cavity 611, and the second end of the light box 610 is constructed with a light outlet hole 613 connected to the containment cavity 611. The luminous device 601 is located in the containment chamber 611 and is close to the assembly opening 612. The concentrator 602 is arranged in the containment cavity 611, and the incident end 603 of the concentrator 602 corresponds to the light-emitting device 612, and the outgoing end 604 corresponds to the light outlet hole 613. According to an exemplary embodiment as indicated schematically, the luminous trim/component C/2 may include a circuit board 605 supplying power to the luminous device 601. Thus, when assembling the luminous trim/component C/2, the assembly opening 612 is bonded with the circuit board 605 to accommodate the luminous device 601 into the containment cavity 611. According to an exemplary embodiment as indicated schematically, a second reflective layer is provided on the inner surface of the accommodating cavity 611 (not shown in the figure). The second reflection layer reflects the light emitted from the side wall 606 of the concentrator 602 into the condenser 602; the arrangement is configured to increase the amount of light entering the cover comprising light-transmissive/guide layer T/30 and thereby helps to increase the brightness of the pattern presented by the luminous trim/component C/2.

According to an exemplary embodiment as indicated schematically in FIG. 13, the light source LS/60 may comprise an end cap 620. The end cap 620 is set at the second end of the light box 610. On the end cap 620 there is a through hole 621 corresponding to the light outlet hole 613. The size of the through hole 621 is matched with the size of the incident surface 314 of the light guide layer 30, so as to facilitate the alignment of the incident surface 314 of the light guide layer T/30 with the through hole 621, which in turn helps to make the light emitted from the outgoing end 604 of the concentrator 604 into the light guide layer 30. According to an exemplary embodiment as indicated schematically, the light box 610 and the end cap 620 play a protective role in the concentrator 602 and the luminous device 601, and facilitate the assembly of the concentrator 602 and the luminous device 601.

According to an exemplary embodiment as indicated schematically in FIGS. 14 and 14A, the component may comprise a light source LS/60. According to an exemplary embodiment as shown schematically in FIGS. 14 and 14A, the first form of light source is similar, and the second form of light source LS/60 may comprise a luminous device 601, a concentrator 602, and a light box 610. The difference is mainly that the length of the light box 610 of the second form of light source LS/60 is greater than that of the concentrator 602. The section of the light guide layer T/30 including the incident surface 314 extends into the lamp box 610. According to an exemplary embodiment as indicated schematically, the second form of light source LS/60 eliminates the need for an end cap.

According to an exemplary embodiment as indicated schematically in FIGS. 15 and 15A-15B, the component may comprise a light source combined light source LS/61. The combined light source 61 is matched with a light guide layer T/30 with multiple layers. The combined light source 61 may comprise multiple second forms of light source 60. The form of light sources LS/60 are arranged side by side and are aligned separately with the corresponding light guide membrane T/30 to provide light to each light guide membrane T/30 individually. In a combined light source 61, the adjacent second form of light source LS/60 is spaced by a light box 610 to avoid cross-beaming. According to an exemplary embodiment as indicated schematically, a combination of light sources 61 may be used with multiple first forms of light sources 60.

### Exemplary Embodiments—D

According to an exemplary embodiment as shown schematically in the FIGURES, a kind of luminous trim for vehicles may comprise a substrate/matrix and at least one light guide film; the light guide layer may be attached to the matrix; the light-guiding film may comprise a light-emitting surface and a bottom surface opposite the light-emitting surface; the bottom surface may be close to the substrate; a plurality of optical microstructures may be constructed in at least part of the area of the light guide film; the plurality of optical microstructures may form a preset pattern so that the light propagating in the light guide layer changes the propagation direction and may be emitted from the light surface after passing through a plurality of optical microstructures, so that the light guide layer presents the preset pattern. The thickness of the light-guiding film may be less than or equal to 1 mm; there may be multiple light-guiding films; the multiple light-guiding films may be stacked; the preset patterns on each of the light guide films may be the same or different from each other; the preset patterns on different light-guide films may deviate from each other or at least partially overlap each other; the adjacent light-guiding film may be closely attached together; a first reflective layer may be arranged between the substrate/matrix and the light-guiding film; the first reflective layer may reflect at least the light leakage towards the substrate/matrix generated at the optical microstructure into the light-guiding film; the luminous trim may comprise a translucent surface decoration layer; the surface decoration layer may be arranged above the light-emitting surface of the light-guiding film; the surface decoration layer may be closely attached to the luminous surface, or there may be a gap between the surface decoration layer and the luminous surface; the surface decoration layer may comprise a light-transmitting area and a non-light-transmitting area deviating from the light-transmitting area; the light-transmitting area may correspond to the preset pattern; the luminous trim may comprise a bottom surface decoration layer; the bottom surface decoration layer may between the light-guiding film and the matrix; the luminous trim may comprise a transparent protective layer; the protective layer may cover the light-emitting surface of the light-guiding film; the luminous trim may comprise a light source; the light-guiding film may comprise an incident surface connected between the light output surface and the bottom surface; the light source may be set to correspond to the incident surface; the light source may comprise a light-emitting device and a concentrator; the concentrator may comprise an incident end, an outgoing end far away from the incident end, and a side wall connected between the incident end and the outlet end; the light-emitting device may be set to correspond to the incident end; the size of the light-emitting device may match the size of the incident end, so that the light emitted by the light-emitting device may be injected into the condenser; the outgoing end may correspond to the incident surface of the light guide film; the size of the outlet end may match the size of the incident surface, so that the light in the concentrator may enter the light guide film; the light source may comprise a light box; the light box may comprise a holding cavity; the first end of the light box may be constructed with an assembly opening connected with the containment cavity; the second end may be constructed with a light outlet hole connected with the containment cavity; the light-emitting device may be in the containment cavity and may be close to the assembly opening; the concentrator may be arranged in the containment cavity; the incident end of the concentrator may correspond to the light-emitting device; the outgoing end of the concentrator may correspond to the light-emitting hole; a second reflective layer may be provided on the inner surface of the accommodating cavity; the second reflection layer may reflect the light emitted from the side wall of the condenser into the condenser; the light source may comprise an end cap, the end cap may be set at the second end of the light box; a through hole corresponding to the light outlet hole may be constructed on the end cap; the size of the through hole may match the size of the incident surface of the light guide film; the section of the light-guide film including the incident surface may extend into the lamp box through the light-outlet hole; the optical microstructure may be made by any of micro-nano embossing and/or screen printing and/or ultraviolet imprinting and/or etching and/or engraving, etc.; the light-guiding film may comprise a flexible/support substrate; an optical adhesive layer may be attached to the flexible/support substrate; there may be a plurality of pits as a plurality of optical microstructures on the optical adhesive layer; the plurality of pits may form the preset pattern.

According to an exemplary embodiment as shown schematically in the FIGURES, a kind of luminous trim for vehicles may comprise a plurality of light guide films; the plurality of light guide films may be stacked and arranged; a preset pattern comprised of a plurality of optical microstructures may be arranged on each of the light guide films; a plurality of light sources may be set to correspond to the plurality of light guide films respectively, so that the light emitted by each light source may be suitable for shining into the corresponding light guide film; the luminous trim may be configured to enable only one of the light sources to emit light so that the luminous trim displays a corresponding preset pattern on the light guide film; the luminous trim may be configured to enable multiple light sources to emit light at the same time so that the luminous trim displays a combination of corresponding preset patterns on multiple light guide films; the preset patterns on the plurality of light-guiding films may not overlap each other or at least partially overlap each other in the direction perpendicular to the plurality of light-guiding films; the luminous trim may be configured to be suitable for causing one or more light sources to emit light to control the brightness and/or color of the pattern displayed by the luminous trim; the luminous trim may be suitable for being configured to make a plurality of light sources cyclically emit light or extinguish, so as to circulate the light into the corresponding light-guiding film, so that the luminous trim may exhibit a dynamic luminous effect; the luminous trim may be set on the interior trim of the vehicle.

The component may comprise a light-emitting ornament for a vehicle, and an interior ornament for a vehicle. The light-emitting ornament comprises: a substrate/matrix (20), and a light guide layer (30), which is attached to the substrate/matrix (20), wherein the cover comprising light-transmissive/guide layer (30) comprises a light emission surface (310) and a bottom surface (311) opposite the light emission surface (310), and the bottom surface (311) is close to the substrate/matrix (20); a plurality of optical micro-structures (312) are constructed in at least some regions of the cover comprising light-transmissive/guide layer (30), and the plurality of optical micro-structures (312) form a preset pattern (313); after light rays (301) propagating in the cover comprising light-transmissive/guide layer (30) pass through the plurality of optical micro-structures (312), the light rays (301) change the propagation directions thereof, and exit from the light emission surface (310), so as to present the preset pattern (313) on the light emission surface (310); and the light rays (301) which do not pass through the optical micro-structures (312) do not exit from the light emission surface (310). According to an exemplary embodiment as indicated schematically, the pattern on the light emission surface is clear and sharp, such that the light-emitting ornament requires no shielding plate and light homogenizing film, thereby facilitating a reduction in the thickness of the light-emitting ornament, and thus facilitating the use of the light-emitting ornament in narrow spaces.

### Exemplary Embodiments—E

As automobiles gradually develop into an indispensable means of transportation in people's daily travel, people have higher requirements for the comfort of automobile interior space, so high integration and lightweight have become a major trend in automobile development. Traditional surface light-emitting structures mostly use light guide plates; ultra-thin light guide films gradually occupy a place in surface light-emitting structures with their unique advantages; such arrangements are membrane structures generally difficult to directly design and install the structure.

According to an exemplary embodiment as shown schematically in the FIGURES, a component may be provided with a composite structure comprising a cover with a light-transmissive layer such as a photo guide film directly laminated with the substrate such as a backplate structure or surface material through insert injection molding/optical bonding, etc., which may better combined with internal components on the premise of giving full play to the advantages of the photo guide film itself, and applied to the surface luminescent structure of automobile sunroof, door panel, instrument panel, smart surface, floor console, etc., to realize the luminous design in narrow spaces.

According to an exemplary embodiment as shown schematically in the FIGURES, the composite structure may be comprised of a cover comprising light-transmissive/guide layer and the substrate/structure layer, which may be densely or not densely bonded together by but not limited to insert injection molding, optical bonding, etc. Some areas in the cover comprising light-transmissive/guide layer are treated with micro-nano imprint to form a micro-nano imprint area. When the incident light enters from the side of the cover comprising light-transmissive/guide layer at a certain angle, the light will be fully reflected inside the cover comprising light-transmissive/guide layer; when the light passes through the micro-nano imprint area, the light angle no longer meets the total reflection condition, and the light will be refracted away from the cover comprising light-transmissive/guide layer, and the scattered light may be observed by the observer. According to an exemplary embodiment as indicated schematically, a pattern may be formed in the cover comprising light-transmissive/guide layer, which is actually composed of micro-nano imprint dot matrix, that is, the size of these dots is in the micro-nano scale, and by controlling the number and density of the micro-nano imprint dot matrix, a variety of patterns or even patterns with three-dimensional effects may be formed, which are clearer and no longer need a homogeneous film in the structure. Traditional light guide plate: use laser dots, ink printing, etc. to form a millimeter-level dot substrate/matrix on the light guide plate, the light is scattered where these points are located, and total reflection occurs in other areas, because the millimeter-level dot substrate/matrix is large, so it needs to be used with a homogenized film to prevent the generation of light spots, and it is necessary to make a transmitted pattern through silk screen printing and other technologies, and finally achieve the effect of luminescence according to the required pattern.

According to an exemplary embodiment as shown schematically in the FIGURES, a component may comprise a luminous trim component for use in vehicles. The component shown as a luminous trim component may comprise a substrate, and at least one light-guide film attached to the substrate; The light guide cover/film may comprise the light emitting surface and the bottom surface opposite the light output surface, and the bottom surface is close to the substrate; At least part of the light guide film is constructed with multiple optical microstructures, and multiple optical microstructures form a preset pattern, so that the light propagating in the light guide film passes through multiple optical microstructures, changes the propagation direction and shoots out from the light surface to present the preset pattern on the light surface.

According to an exemplary embodiment as indicated schematically in the FIGURES, the thickness of the light guide film is less than or equal to 1 mm.

According to an exemplary embodiment as indicated schematically in the FIGURES, the number of light guide films is plural, and multiple light guide film layering is set up; The preset patterns on each light guide film are the same or different from each other; The preset patterns on different light guide films deviate from each other or at least partially overlap each other.

According to an exemplary embodiment as indicated schematically in the FIGURES, adjacent light-guide films are tightly fitted together.

According to an exemplary embodiment as indicated schematically in the FIGURES, a first reflective layer is provided between the substrate/matrix and the light guide film; The first reflective layer reflects at least the light leakage towards the substrate generated at the optical microstructure into the light guide film.

According to an exemplary embodiment as indicated schematically in the FIGURES, the luminous trim may comprise a translucent surface decoration layer set above the light emitting surface of the light guide film.

According to an exemplary embodiment as indicated schematically in the FIGURES, the surface finish layer is closely attached to the light output surface, or there is a gap between the surface finish layer and the light output surface.

According to an exemplary embodiment as indicated schematically in the FIGURES, the surface decoration layer may comprise a light-transmitting area and a non-light-transmitting area deviating from the light-transmitting area, and the light-transmitting area corresponds to a preset pattern.

According to an exemplary embodiment as indicated schematically in the FIGURES, the luminous trim may comprise a bottom modification layer, which is between the light guide film and the substrate.

According to an exemplary embodiment as indicated schematically in the FIGURES, the luminous trim may comprise a transparent protective layer that covers the light emitting surface of the light guide film.

According to an exemplary embodiment as indicated schematically in the FIGURES, the luminous trim may comprise a light source; The light guide film may comprise an incident surface connected between the light output surface and the bottom surface, and the light source is set to correspond to the incident surface.

According to an exemplary embodiment as indicated schematically in the FIGURES, the light source may comprise a light-emitting device and a concentrator; The condenser may comprise the incident end, the outgoing end away from the incident end, and the sidewall connected between the incident and outlet ends; The light-emitting device is set to correspond to the incident end and the size of the light-emitting device matches the size of the incident end so that the light emitted by the light-emitting device enters the condenser; The outlet corresponds to the incident surface of the light guide film, and the size of the outlet side matches the size of the incident surface to allow the light in the concentrator to enter the light guide film.

According to an exemplary embodiment as indicated schematically in the FIGURES, the light source comprises: a light box with a containment cavity; The first end of the light box is constructed with an assembly opening connected to the containment cavity, and the second end is constructed with a light outlet hole connected to the containment cavity. The light-emitting device is in the containment chamber and close to the assembly opening; The condenser is set in the containment chamber, and the incident end of the condenser corresponds to the light-emitting device and the outlet end corresponds to the light outlet hole.

According to an exemplary embodiment as indicated schematically in the FIGURES, a second reflective layer is provided on the inner surface of the accommodating cavity; The second reflective layer reflects light from the side walls of the condenser into the condenser.

According to an exemplary embodiment as indicated schematically in the FIGURES, the light source may comprise: an end cap, the end cap is set at the second end of the light box, and a through hole corresponding to the light outlet hole is constructed on the end cap, and the size of the through hole matches the size of the incident surface of the light guide film.

According to an exemplary embodiment as indicated schematically in the FIGURES, the section of the light guide film including the incident surface extends into the light box through the light outlet hole.

According to an exemplary embodiment as indicated schematically in the FIGURES, the optical microstructure is made by any of the following types: micro-nano imprinting, screen printing, ultraviolet imprinting, etching, and engraving.

According to an exemplary embodiment as indicated schematically in the FIGURES, the light-guiding film may comprise a flexible/support substrate and an optical adhesive layer attached to the flexible/support substrate; There are multiple pits on the optical adhesive layer that act as multiple optical microstructures, and the multiple pits form a preset pattern.

According to an exemplary embodiment as shown schematically, a component may comprise a luminous trim component for use in vehicles. Luminous trim may comprise: multiple light guide films, multiple light guide film stacking settings; A preset pattern composed of multiple optical microstructures is set on each light guide film; and multiple light sources, which are set to correspond to multiple light guide films respectively, so that the light emitted by each light source is suitable for entering the corresponding light guide film; Among them, the luminous trim is configured to make only one light source emit light, so that the luminous trim displays the preset pattern on the corresponding light guide film; Or make multiple light sources emit light at the same time so that the luminous trim displays a combination of preset patterns on the corresponding multiple light guide films.

According to an exemplary embodiment as indicated schematically in the FIGURES, along the direction perpendicular to the plurality of light guide films, the preset patterns on multiple light guide films do not overlap each other or at least partially overlap each other; The illuminated ornament is configured to emit light from one or more light sources to control the brightness and/or color of the pattern displayed by the glowing ornament.

According to an exemplary embodiment as indicated schematically in the FIGURES, the luminous ornament is suitable for being configured to cycle or extinguish multiple light sources to circulate light into the corresponding light guide film, so that the luminous ornament shows a dynamic luminous effect.

According to an exemplary embodiment as shown schematically, a component may comprise an interior trim component for use in vehicles. As indicated schematically, the arrangement interior trim may comprise the illuminated trim for the vehicle as on which the luminous trim is set.

According to an exemplary embodiment as shown schematically, the component comprising the luminous trim component may be used in the vehicle interior; the component may comprise a plurality of optical microstructures constructed in at least part of the area of the light guide film; a plurality of optical microstructures forms a preset pattern. When using luminous trim, the light propagated in the light guide film passes through multiple optical microstructures, changes the direction of propagation and ejects from the light emitting surface to present the preset pattern on the light emitting surface. Light that has not undergone optical microstructure does not emit from the light surface. According to an exemplary embodiment as indicated schematically, the pattern on the luminous surface is clear and sharp, so that the luminous trim does not need the shield and homogenized film in the existing technology; the arrangement is configured to reduce the thickness of the luminous trim and make it easier to use the luminous trim in small spaces.

According to an exemplary embodiment as shown schematically in the FIGURES, the cover comprising light-transmissive/guide layer may be composed of a single layer or multiple layers of light guide film to achieve dynamic multi-color lighting effects. The light guide film, the light guide film and the light guide film are bonded together through the lamination layer, which may be irradiated with different color light sources by means of optical lamination and direct lamination. Some light rays in the photo guide film no longer meet the total reflection condition after passing through the micro-nano imprint area, and are refracted away from the photo guide film. Some rays in the light guide film no longer meet the total reflection condition after passing through the micro-nano imprint area, and are refracted away from the light guide film and enter the light guide film; the light still does not meet the total reflection condition in the re-light guide film, and leaves the light guide film again after refraction. According to an exemplary embodiment as indicated schematically, the light rays in the photo guide membrane that pass through the micro-nano imprint region and then refract the light from the photo guide membrane will pass directly through the photo guide membrane and the photo guide membrane and are finally observed by the observer. As indicated schematically, dynamic colorful lighting effects may be realized. Further set the pattern corresponding to the micro and nano imprint area on different light guide films and the light source color corresponding to each layer of light guide film to achieve dynamic and colorful lighting effects.

According to an exemplary embodiment as shown schematically in the FIGURES, in the cover comprising light-transmissive/guide layer, after the light passes through the micro-nano imprint area, although most of the light will be reflected first and then refracted away from the cover comprising light-transmissive/guide layer and enter above it, which is convenient for the observer to observe, some light will still be refracted into the micro-nano imprint area. According to an exemplary embodiment as indicated schematically, a reflective coating may be added above the skeleton layer, which may reflect these light rays entering the micro-nano imprint area, so that these light rays may eventually enter the upper part of the cover comprising light-transmissive/guide layer so that it is easy for the observer to observe, thereby increasing the final display brightness of the pattern. As indicated schematically, the arrangement reflective coating may comprise; is not limited to, PVD, painting, or using white material as the blackout skeleton material, depending on the brightness requirements of the structure.

According to an exemplary embodiment as shown schematically in the FIGURES, the hierarchical structure from top to bottom is the surface material layer, the cover comprising light-transmissive/guide layer and the skeleton layer, at which time the surface material layer meets a certain transmittance (can be adjusted according to the actual product brightness requirements), which may be but not limited to real materials (translucent wood, crystal, translucent leather, etc.), flexible/support materials and injection molding resin materials (through dyeing, painting, silk screen printing, pad printing, etc. to achieve special patterns, etc.), high light transmittance foam with soft touch, etc. The hierarchy is from top to bottom as the cover comprising light-transmissive/guide layer, the surface material layer and the skeleton layer, in which case the surface material layer may be but not limited to texture coating, etc. When the cover comprising light-transmissive/guide layer is directly located on the surface of the structure, its light is not affected by other layers, and there will be no color cast, which may achieve higher brightness and clarity; However, the light guide film is generally made of PC material, its hardness is HB level, when it is used as a surface, the hardness may not reach the standard, at this time, its surface may be treated, such as spraying hardening coating, adding transparent PC layer, etc.

According to an exemplary embodiment as shown schematically in the FIGURES, if the width of the light source is greater than the thickness of the light guide film, a condenser may be added between the two to allow as much light as possible to enter the light guide film, and the shape of the concentrator is preferably wedge-shaped. The light source is mounted on the substrate, which may be a PCB or an FPC board, etc., and may be set up with a light box and a jaw and other mounting structures for the relative position of the fixed light source, the concentrator and the light guide film.

According to an exemplary embodiment as shown schematically in the FIGURES, a component for a vehicle interior may be configured to be illuminated by light from a light source; the component may comprise a composite structure comprising a substrate configured to provide a substrate/matrix and a cover comprising a light guide material for the substrate/matrix and a set of features; the light guide material may comprise a light guiding film attached to the matrix; the light-guide material may comprise a light-emitting surface and a bottom surface opposite the light-emitting surface; the bottom surface may be close to the substrate; the set of features may comprise a plurality of optical microstructures in at least part of the area of the light guide material; the plurality of optical microstructures may form a preset pattern so that the light propagating in the light guide film changes the propagation direction and may be emitted from the light surface after passing through a plurality of optical microstructures, so that the light guide film presents the preset pattern. The thickness of the light-guiding film may be less than or equal to 1 mm; the component may comprise multiple light-guiding films; the multiple light-guiding films may be stacked; the preset patterns on each of the light guide films may be the same or different from each other; the preset patterns on different light-guide films may deviate from each other or at least partially overlap each other; the adjacent light-guiding film may be closely attached together; a first reflective layer may be arranged between the substrate/matrix and the light-guiding film; the first reflective layer may reflect at least the light leakage towards the substrate/matrix generated at the optical microstructure into the light-guiding film; the component may comprise a translucent surface decoration layer; the surface decoration layer may be arranged above the light-emitting surface of the light-guiding film; the surface decoration layer may be closely attached to the luminous surface, or there may be a gap between the surface decoration layer and the luminous surface; the surface decoration layer may comprise a light-transmitting area and a non-light-transmitting area deviating from the light-transmitting area; the light-transmitting area may correspond to the preset pattern; the component may comprise a bottom surface decoration layer; the bottom surface decoration layer may between the light-guiding film and the matrix; the component may comprise a transparent protective layer; the protective layer may cover the light-emitting surface of the light-guiding film; the component may comprise a light source; the light-guiding film may comprise an incident surface connected between the light output surface and the bottom surface; the light source may be set to correspond to the incident surface; the light source may comprise a light-emitting device and a concentrator; the concentrator may comprise an incident end, an outgoing end far away from the incident end, and a side wall connected between the incident end and the outlet end; the light-emitting device may be set to correspond to the incident end; the size of the light-emitting device may match the size of the incident end, so that the light emitted by the light-emitting device may be injected into the condenser; the outgoing end may correspond to the incident surface of the light guide film; the size of the outlet end may match the size of the incident surface, so that the light in the concentrator may enter the light guide film; the light source may comprise a light box; the light box may comprise a holding cavity; the first end of the light box may be constructed with an assembly opening connected with the containment cavity; the second end may be constructed with a light outlet hole connected with the containment cavity; the light-emitting device may be in the containment cavity and may be close to the assembly opening; the concentrator may be arranged in the containment cavity; the incident end of the concentrator may correspond to the light-emitting device; the outgoing end may correspond to the light-emitting hole; a second reflective layer may be provided on the inner surface of the accommodating cavity; the second reflection layer may reflect the light emitted from the side wall of the condenser into the condenser; the light source may comprise an end cap; the end cap may be set at the second end of the light box; a through hole corresponding to the light outlet hole may be constructed on the end cap; the size of the through hole may match the size of the incident surface of the light guide film; the section of the light-guide film comprising the incident surface may extend into the lamp box through the light-outlet hole; the optical microstructure may be made by any of micro-nano embossing and/or screen printing and/or ultraviolet imprinting and/or etching and/or and engraving, etc.

According to an exemplary embodiment as shown schematically in the FIGURES, a kind of luminous trim for vehicles may comprise a substrate/matrix and at least one light guide film; the light guide film may be attached to the matrix; the light-guiding film may comprise a light-emitting surface and a bottom surface opposite the light-emitting surface; the bottom surface may be close to the substrate; a plurality of optical microstructures may be constructed in at least part of the area of the light guide film; the plurality of optical microstructures may form a preset pattern so that the light propagating in the light guide film changes the propagation direction and may be emitted from the light surface after passing through a plurality of optical microstructures, so that the light guide film presents the preset pattern. The thickness of the light-guiding film may be less than or equal to 1 mm; there may be multiple light-guiding films; the multiple light-guiding films may be stacked; the preset patterns on each of the light guide films may be the same or different from each other; the preset patterns on different light-guide films may deviate from each other or at least partially overlap each other; the adjacent light-guiding film may be closely attached together; a first reflective layer may be arranged between the substrate/matrix and the light-guiding film; the first reflective layer may reflect at least the light leakage towards the substrate/matrix generated at the optical microstructure into the light-guiding film; the luminous trim may comprise a translucent surface decoration layer; the surface decoration layer may be arranged above the light-emitting surface of the light-guiding film; the surface decoration layer may be closely attached to the luminous surface, or there may be a gap between the surface decoration layer and the luminous surface; the surface decoration layer may comprise a light-transmitting area and a non-light-transmitting area deviating from the light-transmitting area; the light-transmitting area may correspond to the preset pattern; the luminous trim may comprise a bottom surface decoration layer; the bottom surface decoration layer may between the light-guiding film and the matrix; the luminous trim may comprise a transparent protective layer; the protective layer may cover the light-emitting surface of the light-guiding film; the luminous trim may comprise a light source; the light-guiding film may comprise an incident surface connected between the light output surface and the bottom surface; the light source may be set to correspond to the incident surface; the light source may comprise a light-emitting device and a concentrator; the concentrator may comprise an incident end, an outgoing end far away from the incident end, and a side wall connected between the incident end and the outlet end; the light-emitting device may be set to correspond to the incident end; the size of the light-emitting device may match the size of the incident end, so that the light emitted by the light-emitting device may be injected into the condenser; the outgoing end may correspond to the incident surface of the light guide film; the size of the outlet end may match the size of the incident surface, so that the light in the concentrator may enter the light guide film; the light source may comprise a light box; the light box may comprise a holding cavity; the first end of the light box may be constructed with an assembly opening connected with the containment cavity; the second end may be constructed with a light outlet hole connected with the containment cavity; the light-emitting device may be in the containment cavity and may be close to the assembly opening; the concentrator may be arranged in the containment cavity; the incident end of the concentrator may correspond to the light-emitting device; the outgoing end of the concentrator may correspond to the light-emitting hole; a second reflective layer may be provided on the inner surface of the accommodating cavity; the second reflection layer may reflect the light emitted from the side wall of the condenser into the condenser; the light source may comprise an end cap, the end cap may be set at the second end of the light box; a through hole corresponding to the light outlet hole may be constructed on the end cap; the size of the through hole may match the size of the incident surface of the light guide film; the section of the light-guide film including the incident surface may extend into the lamp box through the light-outlet hole; the optical microstructure may be made by any of micro-nano embossing and/or screen printing and/or ultraviolet imprinting and/or etching and/or engraving, etc.; the light-guiding film may comprise a flexible/support substrate; an optical adhesive layer may be attached to the flexible/support substrate; there may be a plurality of pits as a plurality of optical microstructures on the optical adhesive layer; the plurality of pits may form the preset pattern.

According to an exemplary embodiment as shown schematically in the FIGURES, a kind of luminous trim for vehicles may comprise a plurality of light guide films; the plurality of light guide films may be stacked and arranged; a preset pattern comprised of a plurality of optical microstructures may be arranged on each of the light guide films; a plurality of light sources may be set to correspond to the plurality of light guide films respectively, so that the light emitted by each light source may be suitable for shining into the corresponding light guide film; the luminous trim may be configured to enable only one of the light sources to emit light so that the luminous trim displays a corresponding preset pattern on the light guide film; the luminous trim may be configured to enable multiple light sources to emit light at the same time so that the luminous trim displays a combination of corresponding preset patterns on multiple light guide films; the preset patterns on the plurality of light-guiding films may not overlap each other or at least partially overlap each other in the direction perpendicular to the plurality of light-guiding films; the luminous trim may be configured to be suitable for causing one or more light sources to emit light to control the brightness and/or color of the pattern displayed by the luminous trim; the luminous trim may be suitable for being configured to make a plurality of light sources cyclically emit light or extinguish, so as to circulate the light into the corresponding light-guiding film, so that the luminous trim may exhibit a dynamic luminous effect; the luminous trim may be set on the interior trim of the vehicle.

TABLE A
REFERENCE SYMBOL LIST

| REFERENCE | |
|---|---|
| SYMBOL | ELEMENT, PART OR COMPONENT |
| V/1 | VEHICLE |
| VI | VEHICLE INTERIOR |
| C/2 | COMPONENT |
| | (E.G. INTERIOR COMPONENT, LUMINOUS TRIM COMPONENT, ETC.) |
| CS | COMPOSITE STRUCTURE |
| FT | FEATURE |
| | (E.G. PROJECTION, RECESS, ETC.) |
| PR | PROJECTION |
| IC | IMAGE |
| | (E.G. ICON, DISPLAY, EFFECT, INFORMATION, ETC.) |
| IP/10 | INSTRUMENT PANEL (DASHBOARD) |
| OH/11 | OVERHEAD PANEL |
| | (OVERHEAD CONSOLE/SYSTEM, CEILING) |
| DP/12 | DOOR PANEL |
| SB/20 | SUBSTRATE |
| NL | INTERMEDIATE LAYER |
| | (E.G. BACKING/LAYER, OPAQUE LAYER, REFLECTIVE LAYER, ETC.) |
| DL | INTERMEDIATE/DECORATIVE LAYER |
| | (E.G. TEXTURE/LAYER, BACKING/LAYER, OPAQUE LAYER, |
| | MASK LAYER, REFLECTIVE LAYER, ETC.) |
| T/30 | COVER |
| | (E.G. COVER LAYER, COVER MATERIAL, |
| | LIGHT-TRANSMISSIVE LAYER, LIGHT GUIDE LAYER, |
| | LIGHT GUIDE FILM, ETC.) |
| 30A | FIRST MEMBRANE LAYER |
| 30B | SECOND MEMBRANE LAYER |
| 30C | THIRD MEMBRANE LAYER |
| L/301 | LIGHT |
| 302 | MATERIAL/LAYER (E.G. REFLECTION LAYER, ETC.) |
| 303 | LIGHT (E.G. LIGHT EMISSION/LEAKAGE, ETC.) |
| 304A | FIRST PATTERN |
| 304B | SECOND PATTERN |
| 304C | THIRD PATTERN |
| 305 | BOND/ADHESIVE (E.G. BINDER, ETC.) |
| 310 | COATING (E.G. GLOSS, ETC. |
| 311 | SURFACE/LAYER (E.G. UNDERSIDE, ETC.) |
| PR/312 | PROJECTION |
| | (E.G. FEATURE, STRUCTURE/MICROSTRUCTURE, |
| | OPTICAL STRUCTURE, OPTICAL MICROSTRUCTURE |
| PT/313 | PATTERN |
| | (E.G. MATRIX, ARRANGEMENT, PRESET PATTERN, ETC.) |
| 314 | INTERFACE (E.G. INCIDENT SURFACE, ETC.) |
| 321 | SUBSTRATE |
| | (FLEXIBLE/SUPPORT SUBSRATE, DIAPHRAGM SUBSTRATE, ETC.) |
| 322 | FEATURE (E.G. PIT, PROJECTION, RECESS, ETC.) |
| 323 | MATERIAL (E.G. DEPOSITED MATERIAL, COATING, INK, ETC.) |
| 324 | ADHESIVE LAYER (E.G. UV/CURE ADHESIVE LAYER, ETC.) |
| 40 | SURFACE LAYER (E.G. SURFACE FINISHING LAYER, ETC.) |
| 50 | SURFACE LAYER (E.G. UNDERSIDE FINISH LAYER, ETC.) |
| LS/60 | LIGHT SOURCE |
| | (E.G. LIGHT/LAMP, LIGHT/LAMP ASSEMBLY, LIGHT/LAMP MODULE, |
| | LED/LED ARRAY, LIGHTS, ETC.) |
| LS/61 | LIGHT SOURCE |
| | (E.G. LIGHT/LAMP, LIGHT/LAMP ASSEMBLY, LIGHT/LAMP MODULE, |
| | LED/LED ARRAY, LIGHTS, COMBINATION LIGHTS, ETC.) |
| 601 | LIGHT/LAMP (E.G. LIGHT EMITTING DEVICE, LED, ETC.) |
| 602 | CONDENSER |
| 603 | INCIDENT END |
| 604 | EXIT END |
| 605 | CIRCUIT BOARD |
| 606 | SIDEWALLS |
| 610 | LIGHT BOX |
| 611 | HOUSING CAVITY |
| 612 | ASSEMBLY OPENING |
| 613 | LIGHT HOLE |
| 620 | END CAP |
| 621 | THROUGH HOLE |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES All such technology (e.g. as implemented in embodiments, modifications, variations, combinations, equivalents, etc.) is considered to be within the scope of the present inventions of the present patent document.

The invention claimed is:

1. A component for a vehicle interior configured to transmit light from a light source into the vehicle interior comprising:
a composite structure comprising a substrate and a cover and a set of features;
wherein the cover comprises a light-transmissive layer and an exterior surface;
wherein the set of features is configured to direct light from the light source within the light-transmissive layer of the cover toward the exterior surface of the cover;
wherein the composite structure is configured to present a visual effect at the cover;
wherein the visual effect comprises a light effect by light from the light source.

2. The component of claim 1 wherein the visual effect comprises a decorative effect from the composite structure.

3. The component of claim 1 wherein the visual effect comprises the light effect and/or the decorative effect.

4. The component of claim 1 wherein the composite structure is configured to present the visual effect on and/or in the cover.

5. The component of claim 1 wherein the composite structure is configured to present the light effect on and/or within the cover.

6. The component of claim 1 wherein the set of features of the composite structure is configured to present the light effect at the exterior surface of the cover.

7. The component of claim 1 wherein the light effect comprises an image comprising a pattern comprising the set of features.

8. The component of claim 1 wherein the set of features is configured to direct and/or scatter light from the light source within the light-transmissive layer of the cover and to direct and/or scatter light toward the exterior surface of the cover.

9. The component of claim 1 wherein the light effect comprises a three-dimensional color effect.

10. The component of claim 2 wherein the decorative effect comprises a surface effect at the exterior surface of the cover.

11. The component of claim 1 wherein the light source comprises an LED arrangement.

12. The component of claim 1 wherein an interface is provided between the light source and the composite structure.

13. The component of claim 1 wherein the interface comprises a surface on an edge of the cover of the composite structure.

14. The component of claim 1 wherein the composite structure comprises a matrix comprising the set of features.

15. The component of claim 1 wherein the set of features comprises a pattern of projections configured to present the image.

16. The component of claim 1 wherein the set of features comprises a set of optically-reflecting features in a pattern.

17. The component of claim 1 wherein the set of features is formed at the cover by embossing and/or micro-nano embossing and/or printing and/or screen printing and/or imprinting and/or ultraviolet imprinting and/or etching and/or engraving.

18. The component of claim 1 wherein the cover comprises a multi-layer assembly comprising at least one film layer and/or at least one molded layer and/or a coating.

19. The component of claim 1 wherein the cover is formed on the substrate.

20. The component of claim 1 further comprising a console and/or a panel and/or a trim component and/or an instrument panel and/or a door panel and/or a floor console and/or an overhead console.
